(19) United States
(12) Patent Application Publication
(10) Pub. No.: US 2024/0075392 A1
(43) Pub. Date: Mar. 7, 2024

(54) GAMING SYSTEMS AND METHODS WITH AUTOMATED AVATAR PLAY

(71) Applicant: LNW Gaming, Inc., Las Vegas, NV (US)

(72) Inventors: Joel R. JAFFE, Glenview, IL (US); Sarah LEGGETT, Chicago, IL (US); Roger M. SNOW, Las Vegas, NV (US); Kenneth Shawn SOONG, Henderson, NV (US)

(21) Appl. No.: 18/362,138

(22) Filed: Jul. 31, 2023

Related U.S. Application Data
(60) Provisional application No. 63/404,240, filed on Sep. 7, 2022.

(51) Int. Cl. A63F 13/77; A63F 13/792

(52) U.S. Cl. CPC A63F 13/77; A63F 13/792

(57) ABSTRACT

A gaming system comprises player gaming devices presenting digital table games, a blockchain access system, and one or more processors. The one or more processors are configured to receive, via a first player gaming device, a player initiation request for a first player to participate in the digital table games, generate, in response to the request, a first player avatar by assigning an avatar identifier to a blockchain address associated with the first player as a non-fungible token (NFT), generate a set of player characteristic parameters for the first player avatar and link the set of parameters to the NFT, collect game data representing player actions of the first player, update the set of parameters for the first player avatar based on the game data, and generate automatic player actions for the first player avatar without direct player intervention based on the updated set of parameters.

### CROSS-REFERENCE TO RELATED APPLICATIONS

This patent application claims the benefit of priority to U.S. Provisional Application No. 63/404,240, filed Sep. 7, 2022, the contents of which are incorporated by reference herein in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2022, SG Gaming, Inc.

### FIELD OF THE INVENTION

The present invention relates to a technological improvement to gaming systems, gaming machines, and methods and, more particularly, to new and improved avatar generation, sharing, and automated play of games.

### BACKGROUND OF THE INVENTION

Player participation within digital games can be represented through digital avatars that occupy a digital representation of a gaming space. For example, digital avatars may be presented at spaces representing the players and/or dealers around a digital table for play of a digital table game like blackjack. In many known avatar-based systems, these avatars are purely cosmetic, and the corresponding player is an active participant in the digital game through various player inputs.

A technical challenge in such systems is to provide players the ability to participate in digital games with limited or no player input while preserving the play style of the respective player. The automated play may be performed through the representation of the player as the avatar. While automated play can be performed in some games following predefined rules (e.g., blackjack has known betting tables based on the dealer's cards and the player's cards), these rules may not reflect the style of play by the player and/or consider all of the current and historical conditions of the current game. The disconnect between the player and an automated system may leave the player frustrated and unwilling to continue play of the game. Accordingly, what is needed is a technical means to provide automated play that emulates the player (or emulates a play style defined by the player).

Moreover, in addition to or in place of automated play, additional automation or sharing of player experience is desirable and absent in current known systems. For example, a skilled player willing to teach others how to play a particular game is limited by his or her available time. In another example, a player may wish to share his or her play style with friends and the like for automated or semi-automated play of games. Accordingly, what is desired is a means for players to share his or her game experience to other players with limited player intervention. A technical challenge of such features includes accurately emulating the shared game experience while abstracting or obscuring the corresponding data from others that may wish to emulate said experience without consent or compensation to the originating player.

### SUMMARY OF THE INVENTION

According to an embodiment of the present invention, there is provided a gaming system (and corresponding methods) comprising one or more player gaming devices configured to present one or more digital table games of the gaming system, a blockchain access system, and one or more processors. Each of the player gaming devices are accessible by players to participate in the one or more digital table games, wherein player participation is represented through a respective player avatar. The blockchain access system is in communication with one or more blockchain nodes configured to manage one or more blockchains. The one or more processors are configured to receive, via a first player gaming device, a player initiation request for a first player associated with the first player gaming device to participate in the one or more digital table games, generate in response to the player initiation request, a first player avatar for the first player by assigning, via the blockchain access system, an avatar identifier to a blockchain address of the one or more blockchains that is associated with the first player as a non-fungible token (NFT), generate a set of player characteristic parameters for the first player avatar and link the set of player characteristic parameters to the NFT of the avatar identifier, each parameter of the set of player characteristic parameters representing a player tendency within the one or more digital table games, collect in response to the first player participating in the one or more digital table games, game data representing game conditions of the one or more digital table games and player actions of the first player from the participation, update the set of player characteristic parameters for the first player avatar based on the collected game data to emulate historical play of the one or more digital table games by the first player, and generate automatic player actions for the first player avatar within the one or more digital table games without direct player intervention based at least in part on the updated set of player characteristic parameters. In at least some embodiments, the one or more processors are integrated within the playing gaming devices, a gaming server, the blockchain access system, and/or other suitable devices of the gaming system.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a block diagram of an example gaming system using blockchain-based avatar features, according to one or more embodiments of the present disclosure.

FIG. 2 is a flow diagram of an example method for creating NFT-based avatars using a gaming system, according to one or more embodiments of the present disclosure.

FIG. 3 is a flow diagram of an example method for transaction an NFT-based avatar using a gaming system, according to one or more embodiments of the present disclosure.

FIG. 4 is an example data flow diagram for registering and using avatars with a gaming system, according to one or more embodiments of the present disclosure.

FIG. 5 is an example data flow diagram for trading, renting, or otherwise transacting an avatar between players using a gaming system, according to one or more embodiments of the present disclosure.

FIG. 6 is a perspective view of a free-standing gaming machine according to an embodiment of the present invention.

FIG. 7 is a block diagram of an example gaming device, such as a player gaming device or game server, according to one or more embodiments of the present disclosure.

FIG. 8 is a block diagram depicting an example gaming computing environment including a blockchain platform in accordance with example embodiments of the present disclosure.

FIG. 9 is a block diagram depicting an example computing environment including multiple gaming channels over which non-fungible tokens (NFTs) may be actioned to users by a blockchain platform including a digital ledger layer in accordance with example embodiments of the present disclosure.

FIG. 10 is a block diagram depicting an example computing environment including a decentralized architecture for gaming.

FIG. 11 is a block diagram depicting an intermediary server architecture of a gaming computing environment in accordance with example embodiments of the present disclosure.

FIG. 12 illustrates an example graphical user interface of an NFT portal for performing NFT actions in association with a set of NFTs recorded on a blockchain platform in accordance with example embodiments of the present disclosure.

FIG. 13 illustrates an example graphical user interface provided by a cross-channel application of a user computing device in accordance with example embodiments of the present disclosure.

FIG. 14 illustrates an example graphical user interface provided by an NFT portal system in accordance with example embodiments of the present disclosure.

FIG. 15 is a block diagram depicting an example structure of a blockchain in accordance with example embodiments of the present disclosure.

FIG. 16 is a block diagram depicting an example blockchain network in accordance with example embodiments of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

As used herein, the terms “avatar,” “digital avatar,” “game avatar,” and variations thereof refer to a digital representation of a player or other participant of a game. That is, the avatars include one or more distinguishable elements from other avatars, at least one of the distinguishable elements being visibly identifiable by players viewing the game. For example, the avatar may include a unique name, a unique combination of a name and player identifier, and/or a customized visual appearance within the digital presentation of the game. The avatars further include a set of parameters and variables that define one or more play styles. As described herein, the following systems and methods are configured to adjust the set of parameters to emulate the play style of the player corresponding to the avatar. The data elements that form the avatar may be stored together in a centralized database or distributed across several data storage devices. In distributed systems, the data of the avatar is linked together through one or more identifiers to enable devices to retrieve the avatar (e.g., for play of a game) from each distributed data storage device. Although the following systems and methods described herein use the avatars for play of digital games, it is to be understood that such avatars may also be used in games with hybrid presentations (e.g., a physical table game with digital displays).

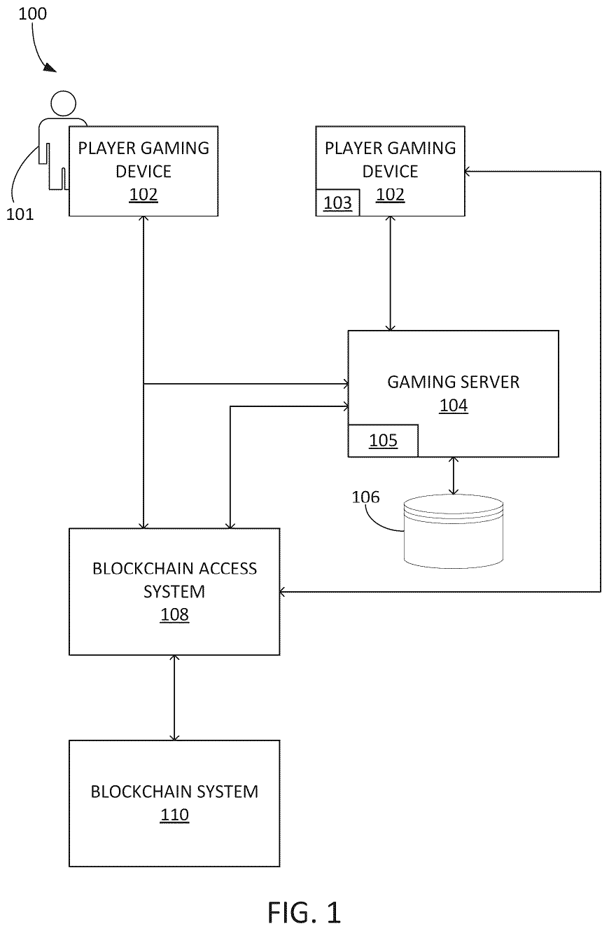

FIG. 1 is a block diagram of an example gaming system 100 using player-based avatars for conducting one or more games. In the example embodiment, the system 100 is configured to conduct digital table games (e.g., blackjack, poker, roulette, craps, etc.). In other embodiments, the system 100 is configured to conduct additional or alternative game types, such as reel-based games, physical table games, and the like. The gaming system 100 includes a plurality of player gaming devices 102, a gaming server 104, an avatar database 106, and a blockchain access system 108 in communication with one or more blockchain systems 110. In other embodiments, the system 100 includes additional, fewer, or alternative devices and subsystems, including those described elsewhere herein.

The player gaming devices 102 are devices that players use to access the system 100 for play of the digital table games. The player gaming devices 102 include devices managed by a gaming environment operator (e.g., a free-standing gaming machine or bartop gaming machine) and/or devices owned by the player (e.g., a smartphone, tablet, laptop, or desktop computer). In the illustrated example, a player 101 is associated with one of the player gaming devices 102. It is to be understood that a player is “associated with” a particular gaming device 102 through active participation within the digital games and/or an account of the player being linked to a particular device, IP address, and the like. Such association may be temporary such that concluding the gaming session at the device 102 and/or another player linking his or her player account to the device 102 removes the association between the device 102 and the previous player.

The player gaming devices 102 include one or more displays to present the game content and/or other content and logic circuitry 103. The logic circuitry 103 includes one or more processors, memory devices, data storage, data buses, and the like that enable the logic circuitry 103 to execute machine-readable instructions and cause the player gaming devices 102 to perform the functionality described herein. For example, presentation of a game and/or other interface by the player gaming device 102 is performed by the logic circuitry 103 causing the display of the device 102 to provide the presentation.

The player gaming devices 102 are configured to present the digital table games to the player and receive player input from the players to participate in the game. In one example, the player 101 provides player input to indicate certain actions within the game, such as betting, folding, requests more cards, and the like. In certain embodiments, one or more of the player gaming devices 102 are configured to conduct at least a portion of the game-logic underlying the digital table game. For example, one player gaming device 102 includes the game-logic to generate random numbers for determining game outcomes within a table game. In another example, the player gaming device 102 generates the presentation of the game outcome and streams or broadcasts the presentation to other player gaming devices 102 participating in the corresponding game. In other embodiments, the game-logic is performed exclusively by the gaming server 104.

The gaming server 104 is configured to manage the digital table games and the player gaming devices 102 participating in the games. The gaming server 104 may be a centralized server or a distributed server, where the server 104 is formed by a plurality of devices. Distributed server systems may divide functionality between devices and/or include several similar computing devices operating in parallel and in communication with each other. The gaming server 104 includes game-logic circuitry 105. Similar to the logic circuitry 103, the game-logic circuitry 105 includes one or more processors, memory devices, data storage, and the like to execute machine-readable instructions and cause the gaming server 104 to perform the functionality described herein. The game-logic circuitry 105 may be centralized or distributed based on the configured of the gaming server 104 as a whole.

In the example embodiment, the digital table games are conducted in combination with avatars representing the players. The avatars include at least one visually distinguishable identifier (e.g., a name, a visual appearance, etc.) viewable on the player gaming devices 102 to enable the players to distinguish between other players. As described in detail further herein, the avatars are data object structures that link together a set of data elements for each avatar.

The data objects of the avatars are stored in an avatar database 106. The avatar database 106 is configured to store data associated with the system 100 and/or other data (e.g., game data or accounting data for other suitable gaming systems). The avatar database 106 may be a centralized database (i.e., a single computing device managing the stored data) or a distributed database. In embodiments with a distributed avatar database 106, the data stored by the database 106 may be stored by different computing devices with or without additional data. The distributed data may be linked together by the gaming server 104 and/or other devices through identifiers, shared data, and the like. It is to be understood that any of the data elements described herein for the system 100 may be stored by the avatar database 106 either as a primary data source or as a backup data source. For example, historical blockchain data described herein stored by other devices in the system 100 (or related to the system 100) may also be stored by the avatar database 106.

In the illustrated embodiment, the avatar database 106 is in communication with the gaming server 104 to store data collected and/or generated by the gaming server 104 and the player gaming devices 102 in communication with the server 104. Additionally or alternatively, the avatar database 106 is in direct communication with other devices, such as the player gaming devices 102 or blockchain access system 108 described herein. It is to be understood that the phrase “direct communication” indicates the absence of an intermediary device (i.e., the gaming server 104) beyond the network devices (e.g., modems, routers, etc.) required to facilitate communication between the two devices. In certain embodiments, the avatar database 106 is at least partially integrated into another device of the system 100, such as the gaming server 104. In such embodiments, the data and/or the functions of the avatar database 106 described herein may be performed by the devices integrating the avatar database 106.

In the example embodiment, data for the avatars is stored in the avatar database 106 and one or more blockchains. Blockchains are digital ledger systems that, through an interconnected system of nodes maintaining separate copies of a digital ledger that store data, digital assets, and records of transactions relating to the stored data and assets. These data elements of the digital ledger may be collectively referred to as “blockchain assets” as used herein. As described in detail herein, the data may be digital assets themselves (e.g., an image file), references or keys for digital assets like a pointer to data stored within the avatar database 106, a set of automated executable instructions known as “smart contracts” for automatically performing actions associated with the blockchain assets.

Blockchains facilitate a “peer-to-peer” sharing of digital assets, such as avatars. That is, users participate within a given blockchain via a blockchain address unique to the user and a hidden key. The blockchain address is publicly used within the blockchain to assign, trade, and otherwise transact the digital assets stored by the blockchain. The hidden key is used in combination to authenticate a user as the owner of a blockchain address and authorize transactions associated with the address. That is, cryptographic functions or data are solved, deciphered, or otherwise indicate the user is authorized by applying the hidden key to the functions or the cryptographic data to the key. Cryptographic authentication and authorization using public-private key pairs are defined by the particular blockchain, and it is to be understood that the system 100 is configured to adapt to the specifications of the given blockchain. To secure the cryptographic authentication and authorization data, the player and other participants in the blockchain use cryptographic wallets (digital, physical, etc.) to manage transactions and the like associated with a blockchain address and its corresponding digital assets. In at least some embodiments, the crypto wallets are configured to interface with or link to external systems to facilitate the integration between a blockchain and the external systems.

In the example embodiment, the system 100 includes a blockchain access system 108 in communication with a blockchain system 110. The blockchain system 110 includes one or more blockchain nodes (i.e., computing systems) that participate in one or more blockchains. The blockchain nodes are configured to maintain respective copies of the blockchain digital ledger and/or publish prospective transactions to the corresponding blockchain. The blockchain access system 108 is configured to interface between the devices of the system 100 and the blockchain system 110. That is, the system 100 provides data to the blockchain system 110 and/or retrieves data from the blockchain system 110 through the blockchain access system 108. In addition to reducing the required number of communication links to the blockchain system 110, the blockchain access system 108 facilitates additional security for the system 100 by obscuring the system 100 from the blockchain system 110 and enabling the network security protocols within the system 100 to be configured separate from the network protocols of the blockchain system 110. In other embodiments, the blockchain access system 108 may be integrated within the gaming server 104 such that the functionality of the blockchain access system 108 described herein is performed by the gaming server 104.

In the example embodiment, the blockchain system 110 is configured to store data associated with the system 100 within one or more blockchains. The data includes representations of the avatars used by the system 100. More specifically, each avatar is linked to a unique non-fungible token (NFT) stored by the blockchain system 110. NFTs are unique links to a respective digital asset (i.e., the avatar). The NFT includes data for identifying the digital asset and distinguishing the NFT from other NFTs, even other NFTs tied to digital assets that are functionally and/or aesthetically the same. Some NFTs may include the digital asset, while other NFTs include pointers or links to an external data storage system including the digital asset (e.g., the avatar database 106). The use of pointers or links within the NFT is used to overcome technical limitations of blockchains—namely, the limited data size requirements of NFTs and the immutable nature of the blockchains limiting the ability to dynamically update the NFT in response to the events and conditions described herein.

NFTs are uniquely tied to a single blockchain address and are transferrable between addresses via a transaction. For systems external to the blockchain system 110 that include the use of the NFT (i.e., the system 100), the external systems may authenticate and authorize users to perform actions associated with the particular NFT. In one example, the system 100 verifies a particular player as the owner of an NFT by issuing an authentication challenge via the blockchain system 110 and/or the player gaming device 102 associated with the player. The authentication challenge is configured to determine if the player is associated with the blockchain address that currently owns the NFT. For example, the player may respond to the challenge with an authentication response that is digitally signed using the hidden key associated with the blockchain address. The player gaming device 102, gaming server 104, the blockchain access system 108, and/or the blockchain system 110 are configured to verify the authentication response and authorize the player for subsequent actions associated with the NFT.

The blockchain access system 108 is configured to communicate with the blockchain system 110 to publish transactions within the one or more blockchains associated with the system 100. For example, the blockchain access system 108 is configured to cause the blockchain system 110 to “mint” new NFTs in addition to exchange existing NFTs and other digital assets (e.g., cryptocurrency) between blockchain addresses. “Minting” refers to the action of publishing a new NFT to the blockchain ledger. In certain embodiments, the blockchain access system 108 is uniquely authorized by the blockchain system 110 to mint NFTs such that minting requests from other devices are automatically denied. Additionally or alternatively, the blockchain access system 108 is uniquely authorized to publish transactions of existing NFTs to the blockchain system 110. In such embodiments, additional or alternative authentication and/or authorization challenges may be posed by the blockchain access system 108 to the players and/or devices requesting a transaction. It is to be understood that “unique authorization” in this context is limited to the system 100 and the functionality of the system 100. That is, other systems unrelated to the system 100 may also be authorized to publish transactions to the blockchain system 110.

In the example embodiment, the NFTs include avatar NFTs, where each avatar NFT is uniquely associated with an avatar of the system 100. Each avatar may correspond to a player, or players may be able to generate several avatars. The avatars are configured to facilitate automated and/or assisted play of one or more games conducted by the system 100. In addition to the visual or cosmetic elements of the avatars, the avatars include parameters or variables that define play styles within the games managed by the system 100. These parameters, when applied to the current state of a particular game (including previous outcomes) through one or more mathematical and/or logical operations, result in a suggested game action (or set of suggested game actions). For example, one parameter may affect the aggressiveness of a player in placing wagers or performing a particular action (e.g., hitting in blackjack), while another parameter affects the resulting action from a particular game condition (e.g., the current player hand, the community cards, and the hands of other players in a poker game). Parameters may be defined as single value variables, arrays of variables, mathematical and/or logical operations, data objects, and/or other suitable data structures that are applied to the current game conditions to generate suggested game actions. In the example embodiment, the suggested game actions are not necessarily optimal game strategy, but rather are configured to emulate the player (or another player as described herein).

The avatar parameters are stored within the avatar database 106 and associated with an avatar identifier stored as an NFT on a blockchain of the blockchain system 110. Such a storage configuration enables the avatar parameters to be dynamically adjusted after the NFT is minted while maintaining an immutable identifier linked to the avatar for facilitating peer-to-peer transactions of the NFT and avatar. In other embodiments, at least a portion of the avatar parameters are included within the NFT of the avatar.

To facilitate the emulation of the player, the parameters of a given avatar are dynamically updated through the use of a data set associated with the player. The data set is collected through play of a corresponding game, and the parameters of the player are responsively updated to the data set. The player data within the data set is collected through play of the games conducted by the system 100 and/or other systems that conduct the same or similar games. For example, the parameters associated with a poker game may be adjusted in response to the player playing the poker game external to the system 100 (e.g., at a physical gaming table) provided player data for the game is collected and provided to the system 100.

In the example embodiment, the suggested player actions are used to enable the avatar to automatically play one or more games without direct intervention of the associated player. The avatar is added to a gaming session of a game with a corresponding credit balance, and the avatar automatically performs the suggested player actions (e.g., wagering, requesting cards, discarding cards, etc.) based on the stored avatar parameters to participate within the game. In at least some embodiments, the player initiates the automated play by applying credits to a credit balance and specifying a set of conditional thresholds to indicate when the automated gaming session is to be concluded. For example, the player applies 1500 credits to the credit balance of the avatar for play of a poker game and indicates the gaming session is to conclude if the credit balance reaches zero or 5000 credits or if the number of rounds played exceeds fifty rounds. Other suitable limits, thresholds, and/or variables may be defined by the player and/or the operator of the system 100 to limit the automated gaming session. In certain embodiments, additionally or alternatively, the player can selectively terminate the automated gaming session.

The automated gaming session is conducted and monitored to generate a log of the automated gaming session. The log may be used, for example, for player review, generation of highlights, and/or other suitable actions. In certain embodiments, the system 100 enables the player to selectively provide feedback to the player actions performed during the automated gaming sessions, which may be used to update the avatar parameters.

In some embodiments, the suggested player actions are used within a gaming session of the player. That is, the suggested player actions are provided to the player throughout the gaming session, thereby enabling the player to choose the suggested player action or deviate from the suggested player action. This is beneficial, for example, for players looking to correct or improve their playing habits or players wanting to quickly identify if they are deviating from their preferred playstyle. In certain embodiments, the suggested player actions may include additional detail for the player to review, such as the parameters that primarily influenced the selection of a particular and/or other suggested player actions.

In at least some embodiments, the avatars can be transferred, shared, or otherwise transacted between players. In one example, a player can purchase an avatar from another player for play of automated gaming sessions. In another example, a player purchases or rents an avatar for training within one or more games, where the avatar provides suggested player actions for the player to compare to their intended action. In a further example, an experienced player can “mentor” avatars by providing additional historical game data that adjust the parameters of the avatar and send the updated avatars back to the originating player. In yet another example in which players can manually adjust avatar parameters, one player adept at generating desirable avatars can configured the avatar parameters of a given avatar to auction or sell to other players.

The transactions of the avatars are facilitated through the transmittal of the NFTs on the blockchain system 110. That is, to facilitate the sale of avatar from a first player to a second player, the first player and second player authorize a transaction of the NFT from a blockchain address associated with the first player to a blockchain address associated with the second player. Once the transaction is applied to the blockchain and verified by the blockchain system 110, the system 100 considers the avatar “owned” by the second player, and therefore the first player is not authorized to perform subsequent actions with the avatar. Ownership of a particular avatar is tracked through the avatar database 106 in response to the blockchain access system 108 identifying the change to the blockchain. In one example, a player identifier of the player is linked to the avatar and NFT. The player identifier may be a player account identifier, the name of the player, the blockchain address, and/or other suitable identifiers linked to the player.

In at least some embodiments, the transactions of avatars may be at least partially automated. More specifically, one or more smart contracts within the blockchain may govern automated transactions or other suitable automated actions. The smart contract includes computer-executable instructions that, when executed by the blockchain system 110, the blockchain access system 108, and/or the gaming server 104, causes one or more automated actions associated with the NFTs to be performed. For example, rental transactions may include a smart contract that automatically transacts the NFT back to the originating player after a period of time. In another example, a fee is automatically paid to an originating player of an avatar for any subsequent transactions of the avatar.

The transactions of the avatars, while performed by the blockchain system 110, require authorization from the players and/or the operator of the system 100. To authorize transactions, the players authenticate themselves as owners of the relevant blockchain addresses (e.g., via digital signatures using a cryptographic key) via the player gaming devices 102 in communication with the blockchain access system 108 and/or other suitable device in communication with the blockchain system 110. The blockchain access system 108 reports the status of a given transaction by monitoring the corresponding digital ledger of the blockchain system 110 and the avatar database 106 is updated accordingly.

In the example embodiment, the functions of the avatars of the system 100 are executed by the player gaming devices 102, the gaming server 104, and/or the blockchain access system 108. That is, these devices retrieve at least a portion of the avatar parameters of an avatar and/or other data elements forming the avatar to generate the suggested game actions. The avatar parameters are applied as inputs to one or more predefined operations that output suggested game actions. The operations may output a single action or a set of weighted suggested actions, where the weighting indicates the likelihood of the emulated player performing a given action. The avatar functions may be incorporated into the game execution (e.g., the gaming server 104 manages the game and the avatars), or the avatar functions may be executed separately.

The player gaming devices 102 are configured to present interfaces incorporating the avatars and the corresponding functions. For regulated gaming devices, such as free-standing electronic gaming machines, the interfaces are integrated into the game software, operating system, and/or support software. In multipurpose devices, such as smartphones, the interfaces may be accessible through dedicated gaming applications. In certain embodiments, the interfaces are accessible via web-based systems or other suitable network means. Examples of the interfaces include, without limitation, an interface to browse available avatars, an interface to customize avatars, an interface for monitoring the suggested player action, and the like. These interfaces may be separate from other interfaces or graphical elements or integrated within other interfaces, such as the interface for viewing and playing a game.

It is to be understood that the foregoing examples of avatar functionality are for exemplary purposes only and are not intended to limit the use of avatars within the system 100. Other suitable uses of avatars emulating players, such as playing “simulated games” for no credits to test game strategies, are considered within the spirit and scope of the present disclosure.

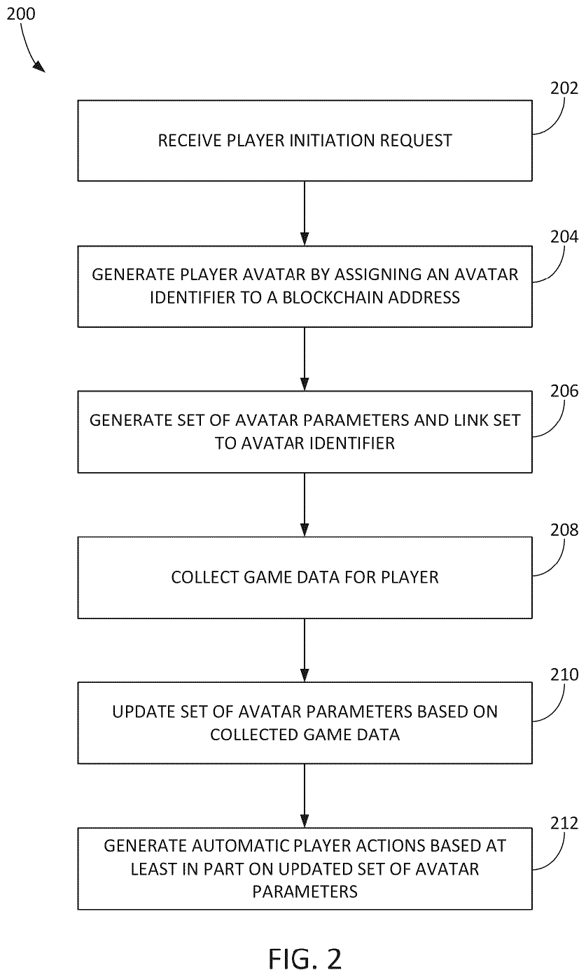

FIG. 2 is a flow diagram of an example method 200 for managing game avatars in a gaming environment. The method 200 is performed by devices of a gaming system, such as the system 100 (shown in FIG. 1). Although the method 200 is described herein primarily with a gaming server performing the illustrated steps, it is to be understood that the steps of the method 200 may be performed by additional or alternative devices within the system. Additionally or alternatively, in certain embodiments, the method 200 includes additional, fewer, or alternative steps, including those described elsewhere herein.

The method 200 begins with receiving 202 a player initiation request from a first player to participate in the games of the gaming system. In some embodiments, the player initiation request is required to participate. In other embodiments, the player initiation request is optional and enables the player to participate at least in the features described herein. The player can provide the player initiation request via a corresponding player gaming device and/or other suitable device (including devices external to the gaming system). The player initiation request includes one or more player identifiers to link the player's identity to an avatar as described herein. In certain embodiments, other identifiers (e.g., device identifier for the originating device associated with the player and the request), parameters, and/or other suitable data is included in the player initiation request.

In the example embodiment, the gaming server receives 202 the player initiation request and generates 204 a player avatar based on the player initiation request. More specifically, the gaming server generates an avatar identifier and links the avatar identifier to the player (e.g., by linking the avatar identifier to the player identifier of the request). In the example embodiment, the avatar is at least partially stored on a blockchain as an NFT. The gaming server, directly or via a blockchain access system, communicates with a blockchain system to “mint” or generate the new NFT for the avatar. In some embodiments, the gaming server passes data to the blockchain system to generate the NFT, such as the avatar identifier and/or a smart contract. In other embodiments, the NFT is generated without input data from the gaming server. In such embodiments, the avatar identifier is generated with the NFT and is provided to the gaming server to link to the player.

Within or following the minting process, the avatar NFT is assigned to a blockchain address associated with the first player. The blockchain address may be provided by the first player (e.g., within the player initiation request), or the blockchain address is assigned by the blockchain system, blockchain access system, and/or the gaming server to the first player and provided to the first player in response to generating the NFT. Providing the blockchain address to the first player may include securely providing authentication data, such as a private key, to the first player. It is to be understood that providing and assigning such data to the first player means the data is transmitted to a device associated with the first player (e.g., a player gaming device) and/or stored with or linked to an account associated with the player.

The generation of an NFT for the avatar is verifiable by the gaming server and/or the blockchain access system monitoring the blockchain. That is, the blockchain nodes of the blockchain system circulate and publish a new “block” including the new NFT being assigned to the blockchain address of the first player (or an intermediary address that subsequently transfers the NFT to the blockchain address of the player). By publishing the NFT to the blockchain, the NFT will persist in the blockchain and enable transfer of ownership of the avatar as described herein.

In the example embodiment, the gaming server is configured to generate 206 a set of avatar parameters for the avatar and link or assign the parameters to the corresponding avatar identifier. The avatar parameters may include, for example, cosmetic parameters and player characteristic parameters. The player characteristic parameters are parameters that impact the automatic player actions described herein, where suggested player actions are automatically generated at least partially as a function of one or more of the player characteristic parameters.

The set of avatar parameters may be generated with one or more parameters at default or initial values. For example, the player characteristic parameters may be initialized at default values that represent standard game strategy and player tendencies. The parameters are adjusted as described herein to emulate or approximate the playing tendencies of the first player. The set of avatar parameters may be stored in an avatar database with the avatar identifier such that the gaming server is configured to retrieve the parameters and/or the avatar identifier from the avatar database for the functions described herein.

In response to generating the avatar and the corresponding parameters, the avatar may be available for presentation to the first player. For example, the avatar may be incorporated into one or more game interfaces of the games conducted by the gaming system. In another example, the avatar is managed by the player via an interface hosted by the gaming server and/or the blockchain access system to manually adjust parameters, such as altering the cosmetic look of the avatar. The avatar management may be limited to the devices of the gaming system or accessible by external devices.

At step 208, the gaming server collects game data associated with the first player. The game data includes historical game play of the player. That is, the game data may include the state of the game, the state of the player (e.g., credit balance), the state of other participating players, and the actions taken by the player. The game data is collected from play of games conducted by the gaming system and/or other suitable games. That is, gaming sessions conducted by other gaming systems, such as systems managing physical table games, can be linked to the gaming system for game data collection. The game data may be limited to data collected following the player initiation request, or the game data may be extended to include data collected prior to the player initiation request provided the game data is identifiably linked to the first player. In some embodiments, the players may selectively elect to the game data collection. For example, a player participating in a game for the first time may elect to prevent game data collection until they have understood the game rules.

At step 210, the gaming server updates the set of avatar parameters (particularly the player characteristic parameters) in response to the game data collection 208. That is, for each parameter associated with the collected game data, the parameter is updated at least partially as a function of the collected game data relevant to the parameter. The mathematical and/or logical operations used to update the parameters are predefined operations stored by the gaming server. In some embodiments, the operations include other data, such as the previous parameter value, previously collected game data, and the like. In certain embodiments, the game data collection may be performed to align with the parameters. That is, the game data is collected in a manner that each game data element aligns with one corresponding parameter. Other suitable methods of applying the game data to the avatar parameters may be used additional or alternatively to the methods described above.

In some embodiments, the steps 208 and 210 are performed at least for a training period following the creation of the avatar. During the training period, the avatar parameters are changed from the initial parameter values that may not match with the play style of the first player, to avatar parameters that emulate the play style of the first player. The functions of the avatar associated with the avatar parameters may be limited until predefine amount of game data is collected and/or the player approves the state of the avatar. In certain embodiments, in addition to the game data collection, the first player may be prompted to provide feedback for the avatar. For example, if the avatar generates a suggested player action as described herein that the player does not agree with, the player can provide feedback that is incorporated into the avatar parameters.

In certain embodiments, the avatar parameters are accessible and manually adjustable by the player. For example, the blockchain access system and/or the gaming server may host an interface accessible by the players (e.g., via the player gaming devices) that include customization options. In another example, the player gaming devices host one or more customization interfaces while in communication with the blockchain access system and/or the gaming server. The customization interfaces may be used to modify cosmetic or other non-gaming parameters and/or player characteristic parameters. The parameters may be directly adjusted, or through abstracted customization options. For example, if the player wishes to adjust the avatar parameters to favor conservative play in a game of blackjack, the player may select a conservative option from the interface that adjusts one or more underlying parameters automatically. Other suitable forms of manual customization of the avatars are considered within the spirit and scope of the present disclosure.

In at least some embodiments, the game data continues to be collected and the parameters updated following the training period such that the avatar is dynamic to adapt to play style changes of the player. In certain embodiments, the player and/or the gaming system can selectively pause (including indefinitely) the automatic updating of the avatar parameters. In one or more embodiments, historical avatar parameters are stored by the avatar database to facilitate rollback of certain parameters. In one example, the player is participating in a game with another player sharing player actions, which may impact the manner in which the original player plays. The player may be provided the option to pause any avatar parameter updates through the game, and/or the player may be provided the option to rollback avatar parameters following the game.

In the example, embodiment, the avatars are used to participate in automated gaming sessions on behalf of the player. That is, the player authorizes the avatar to participate within one or more games without continued input from the player. To participate within the gaming session, the avatar is configured to generate automatic player actions and perform the player actions within the game. Automatic player actions may include, for example, wagers, drawing cards, folding, swapping cards, and/or other suitable actions defined by the games available from the gaming system. More specifically, for an avatar emulating a player, the automatic player action is generated as a likely player action taken by the player when presented with the same game conditions. It is to be understood that the avatar generating automatic player actions refers to a device of the gaming system, such as the gaming server or a player gaming device, retrieving the avatar parameters of the avatar and generating the automatic player actions based at least in part on the avatar parameters at step 212. In at least some embodiments, the automatic player actions are also based on the current game state, the player state (e.g., current credit balance), the opponent state, and/or the like. The avatar parameters and/or other parameters may be input into one or more functions or operations stored by the gaming server or player gaming device to select one or more automatic player actions.

In the example embodiment, the automatic player actions are provided to the game-logic circuitry administering the game in a manner similar to the actions performed by live players. For example, the game-logic circuitry may be configured to provide one or more application program interfaces (APIs) to the player gaming devices for submitting player input and actions in a predefined format for use in executing the game. In another embodiment, the automatic player actions are received and/or processed separate from live player actions. For example, in embodiments in which the gaming server administers the game and generates the automatic player actions, the gaming server may incorporate such automatic player actions directly within the game software or through other dedicated APIs.

As the automatic player actions emulate live player actions, the administration of the game following the reception of the automatic player actions may proceed similar to or the same as games including only live players. That is, game actions are performed based on player actions (e.g., drawing community cards, rolling dice, etc.) and the gaming server or other suitable device is configured to determine and resolve a corresponding game outcome. For example, awards based on the game outcome and the wagers of the players (including avatars) are distributed to winning players. Play of the game continues for subsequent game rounds, and the avatars are configured to generate automatic player actions based on the current state of the game and the avatar parameters until a termination condition is reached. The termination condition may be a predefined condition or set of conditions assigned by the player, such as a predefined number of rounds, a particular credit balance, and/or other suitable conditions, or the termination condition may be external to the control of the player. For example, if the credit balance assigned to the avatar reaches zero without additional credits from the player, the automatic play concludes. In another example, the game itself may conclude (e.g., due to a sufficient number of participants, lack of resources, etc.) prior to reaching the player-defined termination conditions.

In the example embodiment, the automatic play is monitored by the gaming system to generate a historical log of the play. The historical log may be used to generate data, information, and presentations for the corresponding player to review. In one example, a summary of the automatic play is presentable to the player upon request. The summary can include statistics, game states, and the like to the player beyond the final credit balance for analysis. In another example, highlights of the automatic gaming session are recorded and/or recreated from the historical log to present to the player. That is, big wins, near misses, and other notable moments within the automatic gaming session are viewable and shareable by the player (e.g., via the player gaming device). In certain embodiments, the player gaming device and/or the gaming server is configured to receive player feedback based on the historical log to update the avatar parameters and/or adjust the underlying operations that generate automatic player actions. For example, if a player deems an automatic player action to be contrary to their playstyle, the player may provide feedback to discourage that action in subsequent automatic gaming sessions. Conversely, player actions that the player deems to be desirable and/or aligned with their playstyle may be promoted through feedback to the gaming system. In some embodiments, the player may view the live or historical play of the avatar while the automatic gaming session is still active.

In at least some embodiments, the gaming system is configured to perform matchmaking for automatic gaming sessions. That is, the avatars may be limited to participation in games with other avatars or games with avatars and players that consent to playing with avatars. In other embodiments, players may opt-out of games with avatars participating. The avatars may be explicitly identified as avatars within one or more game interfaces to the live participating players.

In fully automated games, the pace of play may exceed standard play with live players or be performed at an irregular, thereby increasing the number of rounds determined within a given duration and/or enabling the gaming system to allocate resources to the automated games within periods of low resource demand. Such implementations enable the underlying devices (e.g., the gaming server) to free up resources for other aspects of the gaming system, such as hosting live gaming sessions. These advantages may be at least partially carried over to mixed gaming sessions including live players, where the live players benefit from increase pace of play. In certain embodiments, the automatic or mixed games are configured to emulate the duration of a corresponding standard live game. In such embodiments, the game determinations and automatic player actions are shown through delayed presentations.

In at least some embodiments, the automatic player actions are not limited to automatic gaming sessions. For example and without limitation, the automatic player actions may be used to detect whether or not a player is deviating from their preferred playstyle, participate as an opponent in practice games, simulate changes to the playstyle of the player, and, as described herein, used to provide training to inexperienced players. Similar to the automatic gaming sessions, these other uses of the avatar and the corresponding automatic player actions may be selectively authorized by the player with predefined conditions that change or terminate the generation of the automatic player actions. The game interfaces and other interfaces hosted by the gaming system are configured to selectively include presentation elements associated with the avatars and the automatic player actions. For example, within a live player game, the player may select a presentation element associated with the avatar to receive a recommendation (i.e., an automatic player action) from the avatar. The player can confirm the recommended action, perform another action based on the recommendation, or altogether ignore the recommendation.

In the example embodiment, the avatars are not limited to uses for the player that generated the avatar (and, by extension, is the player emulated by the avatar). For example, the avatars can be used to train other players, participate in additional automatic gaming sessions (including those beyond the current skill level of a particular player), and/or to emulate additional or other playstyles of additional players. The example embodiment, players can communicate with each other to sell, trade, loan, and/or otherwise transact avatars through the blockchain system hosting the NFTs of the avatars. That is, the gaming system facilitates transactions within the blockchain system for the avatar NFTs, and the ownership changes are reflected within the games and other aspects administered by the gaming system. In other embodiments, such as embodiments without blockchain systems and NFTs, the avatar transactions are performed through other suitable means in which the gaming system authenticates and/or authorizes avatar transactions.

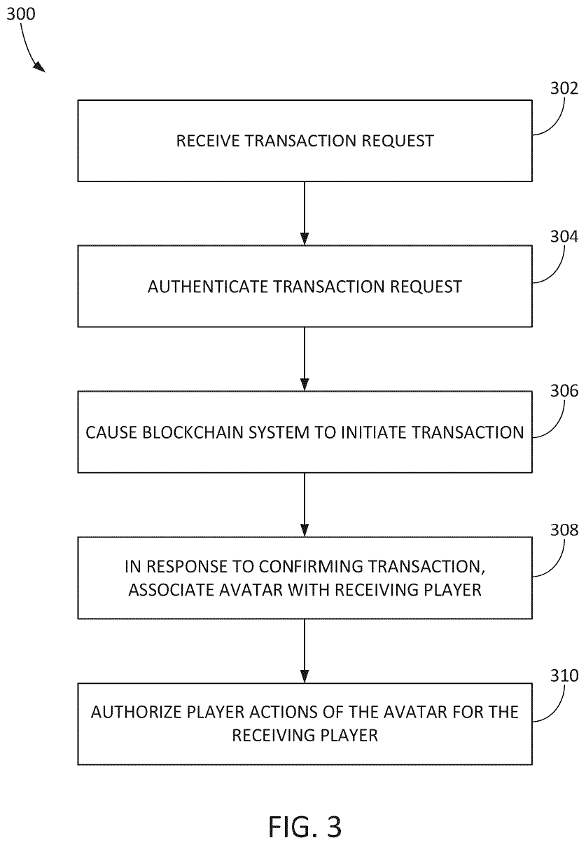

FIG. 3 depicts a flow diagram of an example method 300 for transacting an avatar using a gaming system, such as the gaming system 100 (shown in FIG. 1). The method 300 is at least partially performed by one or more devices of the gaming system, such as the player gaming devices, the gaming server, and the blockchain access system. Other suitable devices and combinations of devices, including those external to the gaming system, may be used for the method 300 in other embodiments. For example, the blockchain nodes of the blockchain system and other personal devices of the players may be used for the steps described herein. Additionally or alternatively, the method 300 may include additional, fewer, or alternative steps, including those described elsewhere herein. It is to be understood that the method 300 describes one form of a transaction between players (i.e., a sale or rental of an avatar), and that the gaming system may be configured to perform other types of transactions using the same or similar steps as the method 300 adapted to the particular transaction type.

In the example embodiment, the method 300 begins with the gaming system receiving a transaction request at step 302. The transaction request is configured to identify the sending and receiving parties and the avatar to be transacted. In one example, the sending and receiving parties are identified by corresponding blockchain addresses, and the avatar is identified by the NFT identifier associated with the avatar. The transaction request may originate from the sender, receiver, or both parties (e.g., the transaction request include two combined requests from the sender and receiver). The transaction request may be received by the player gaming devices, the gaming server, and/or the blockchain access system. In certain embodiments, the request is submitted to the blockchain system directly such that steps 302-306 as described herein are performed external to the gaming system. In the example embodiment, the blockchain access system is configured to receive the transaction request (directly or indirectly) and verify the transaction.

At step 304, the blockchain access system is configured to authenticate the transaction request. Authentication includes verifying the sending party is indeed the owner of the avatar NFT within the blockchain and that both parties consent to the transaction. The blockchain access system, via the blockchain system, verifies the ownership of the avatar NFT through performing a lookup within the corresponding blockchain. Consent to the transaction may be confirmed by verifying authentication data within the transaction request and/or issuing an authentication challenge to the sender and/or receiver.

The authentication data is data that indicates the party submitting the request matches the identity of the sender and/or receiver. For example, the authentication data is data that proves the party submitting the request owns the blockchain address associated with the avatar NFT. In at least some embodiments, the authentication data is cryptographic encoded or decoded data incorporating the cryptographic security of the blockchain (e.g., a digital signature). In other embodiments, the authentication data is stored by the gaming system from an initiation sequence (e.g., the sequence described in step 202 of the method 200, shown in FIG. 2). The authentication data may be provided within the transaction request, or the blockchain access system provides a subsequent authentication challenge to the sender and/or receiver. The authentication challenge may be provided via the blockchain system or through the gaming system, where the authentication challenge is sent to player gaming devices (or other personal devices) of the sender and receiver.

The authentication challenge requests the sender and receiver verify their identity and, by extension, authorize the transaction. The sender and receiver provide the authentication data in response to the challenge to proceed with the transaction. For fraudulent transactions (e.g., transactions that are submitted without consent of the sender or receiver), the sender or receiver can flag or decline the transaction request to prevent the transaction from occurring. Similarly, the sender or receiver can decline authorization of non-fraudulent transactions responsive to the authentication challenge. In embodiments in which the authentication data is included within the transaction request, the blockchain access system may be configured to transmit an authorization request similar to the authentication challenge to the sender and/or receiver to confirm authorization of the transaction.

In response to authenticating and authorizing the transaction, the blockchain access system causes the blockchain system to initiate the transaction of the avatar NFT at step 306. For example, the blockchain access system may submit the transaction to a node of the blockchain system to be distributed and published to the digital ledger of the blockchain. The blockchain access system may be configured as the sole authorizing party of the transaction or as a third authorizing party with the sender and receiver within the blockchain system. In the case of the latter, the authentication of step 304 may be performed by the blockchain system such that failure to authenticate the request causes the blockchain system to prevent the transaction from occurring. Adding the blockchain access system as an authorizing party (e.g., via a smart contract associated with the avatar NFT) enables the gaming system to perform additional authentication and protect avatar owners from fraud external to the gaming system.

The blockchain system is configured to publish the transaction within a block of the digital ledger and verifying said block through a consensus built from the copies of the digital ledger managed by the blockchain nodes. The blockchain access system monitors the blockchain to confirm the transaction has occurred, thereby transferring the avatar NFT from the blockchain address of the sender to the blockchain address of the receiver.

In response to confirming the transaction via the blockchain access system, the gaming server associates the avatar with the receiving player at step 308. More specifically, the gaming server updates the avatar database to reflect the change in ownership. Accordingly, subsequent actions associated with the avatar may be restricted to the receiving player and the sending player is prevented or otherwise limited from said actions with the avatar. To authorize the player actions at step 310, the gaming server may be configured to monitor the avatar database for current avatar ownership or request the blockchain access system determine the current owner via monitoring the blockchain system. The authorization of the player actions may continue for the receiving player until the avatar is no longer in their possession. For example, the receiving player can initiate another transaction to send the avatar back to the original sender or to another player. In one example, the transaction request and/or the avatar NFT includes a smart contract defining a rental period (or other rental conditions). In response to the rental period concluding, the avatar NFT is automatically transacted back to the sender through an automatic transaction request.

In certain embodiments, the originating player (either the player associated with the NFT at the time of minting or the sender within a particular NFT transaction) may be provided limited interactions with the avatar. For example, the originating player may access the avatar parameters of the avatar for generating or updating other avatars. In another example, the originating player may use the avatar as an opposing player in practice games. In yet another example, the avatar may persist for the originating player as a presentation element without access to player actions within one or more interfaces (e.g., a collection of past avatars).

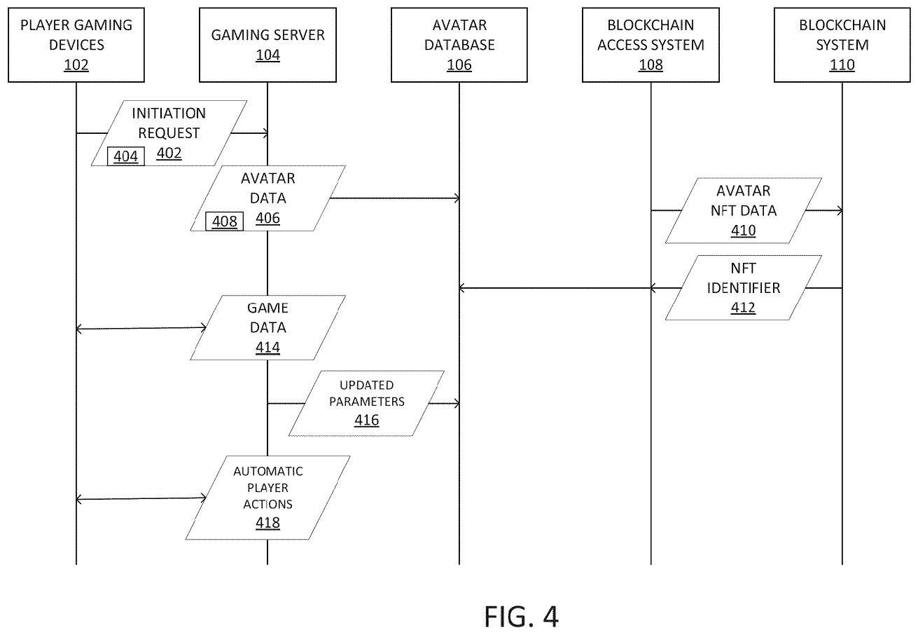

FIG. 4 depicts an example data flow diagram for registering and using avatars with the gaming system 100 (shown in FIG. 1). It is to be understood that the data flow shown in FIG. 4 is for exemplary purposes only and is not intended to limit the data flow facilitating the functionality of the gaming system 100 as described herein. For example, the data described herein may be generated by and/or transmitted to additional, fewer, or alternative recipients (including devices external to the gaming system 100, such as the blockchain system 110). In some embodiments, the data flow includes additional, fewer, or alternative data or data elements, including data described elsewhere herein. The format and structure of the data described herein may be adapted to the protocols of the devices, network, and/or other transmission systems (e.g., data storage device) that facilitate the generation and transmission of the data described herein.

In the example embodiment, a player initiates a registration process. The registration process may be used only to generate a new avatar, or the process may be used to register the player for other aspects of the gaming system 100, such as a player account. The player may be presented with one or more user interfaces to initiate the registration process via a player gaming device 102 and/or other suitable device (e.g., an email or text message may be sent to the player's personal device to initiate the registration process even if the personal device is not registered as a player gaming device 102). In response to player input authorizing the registration process, the player gaming device 102 generates an initiation request 402 to be transmitted to the gaming server 104. In the example embodiment, the initiation request 402 includes one or more player identifiers 404 to link other data described herein to the player's identity. The player identifiers 404 may be personal identifiable information, biometric information, player account numbers, and/or other suitable information associated with the player. In certain embodiments, the player identifiers 404 include a blockchain address associated with the player within a blockchain of the blockchain system 110.

The initiation request 402 may include other data in addition to or in place of the player identifiers 404. For example and without limitation, the request 402 may include a device identifier for the player gaming device 102, avatar customization data, authentication data (for subsequent blockchain transactions described herein), historical game data associated with the player, and the like. The avatar customization data may include preliminary data for tailoring the visual appearance and other non-gaming aspects of the resulting avatar. The historical game data may be used for generating the avatar based on the player's play style as described herein.

In response to the initiation request 402, the gaming server 104 is configured to generate avatar data 406 for an avatar associated with the player and store the data 406 within the avatar database 106. The avatar data 406 includes data that defines various aspects of the avatar, such as, and without limitation, the audiovisual appearance of the avatar, the gaming functions of the avatar, and the like. In the example embodiment, the avatar data 406 includes a set of avatar parameters 408 that define the automatic player actions described herein. The avatar parameters 408 include at least one player characteristic parameter. The set of avatar parameters 408 are initiated at default values predefined by the gaming server 104. In certain embodiments, the avatar parameters 408 are initiated at least partially as a function of historical game data associated with the player, such as the data included within the initiation request or game data maintained by the gaming server 104.

In some embodiments, the avatar data 406 includes one or more avatar identifiers uniquely associated with the avatar. In other embodiments, the avatar data 406 does not initially include an avatar identifier, but rather an avatar identifier is generated within the steps described herein. The avatar data 406 is linked to the player within the avatar database 106 by storing the player identifier 404 with the avatar data 406. It is to be understood that storing the player identifier 404 “with” the avatar data 406 does not limit the data storage structure to embodiments in which both data elements are stored in combination with one another, but may also include embodiments incorporating data pointers and other linked data storage configurations.

In the example embodiment, the gaming server 104 notifies the blockchain access system 108 to initiate a minting transaction for an NFT to be associated with the avatar. A “minting transaction” is an initial transaction generating an NFT on a blockchain and assigning the NFT to a blockchain address, which may be the address of the player or an intermediary address (e.g., a blockchain address associated with the gaming system 100). The blockchain access 108 may request or receive data from the gaming server 104 and/or the player gaming device 102 to define the requested transaction. This received data, which may be combined with data stored or generated by the blockchain access system, is used to generate avatar NFT data 410 to be sent to the blockchain system 110. The avatar NFT data 410 includes, for example and without limitation, one or more identifiers, pointers or links referencing the corresponding avatar data 406 stored in the avatar database 106, a recipient blockchain address (e.g., an address associated with or to be associated with the player), smart contract data, and the like. The smart contract data is data stored within the NFT that defines one or more functions that, in response to certain inputs (e.g., state of the blockchain), are automatically executed by the blockchain system 110. For example, a smart contract can define a rental process of an avatar, where a follow-up transaction returning the avatar to the original owner is automatically executed after a predefined period of time.

In certain embodiments, the blockchain system 110 may request authentication and/or authorization data from the gaming system 100 and/or the player to execute the minting transaction based on the avatar NFT data 410. This data may be preemptively provided by the blockchain access system 108 as part of the avatar NFT data 410, or the blockchain access system 108 is configured to collect the requested from the player and/or the gaming system 100. In some embodiments, the blockchain system 110 may directly request this data from the player through a device external to the gaming system 100.

In response to verifying the validity of the requested transaction, the blockchain system 110 begins a minting process. The minting process includes generating a unique NFT identifier 412 associated with the NFT, storing any smart contract code or other suitable data (e.g., avatar identifiers) as part of the NFT, and assigning the NFT to a blockchain address such that the NFT is controlled by the assigned blockchain address. This process is circulated through a plurality of blockchain nodes such that the transaction is stored in a block of each node's digital ledger. As the block is published, the NFT associated with the avatar is immutably stored and is used to authenticate an owner of the avatar within the gaming system 100. That is, to verify ownership of an avatar, the owner verifies that they are associated with the blockchain address currently storing the NFT of the avatar. Ownership verification may be performed by the blockchain access system 108 by monitoring the blockchain system 110 periodically, in response to changes, and/or within another suitable frequency (e.g., verifying ownership at the beginning of each gaming session). The blockchain access system 108 may store an updated copy of the blockchain to reduce the network resource allocation to ownership verification.

In the example embodiment, the gaming system 100 verifies the completion of the minting process by the blockchain access system 108 receiving the NFT identifier 412. In some embodiments, additional or alternative data is received from the blockchain system 110 to verify the avatar NFT has been minted. For example, and without limitation, blockchain data with a record of the block including the minting transaction can be collected by the blockchain access system 108 and/or a completion notification may be sent from the blockchain system 110 to the blockchain access system 108. The NFT identifier 412 is linked to the corresponding avatar data 406 and stored in the avatar database 106. The avatar data 406 and the NFT identifier 412 are linked to one or more identifiers of the player (e.g., the player identifier 404) to indicate the current owner of the avatar. As described above, the verification of the avatar ownership is updated in response to transactions involving the avatar. Maintaining an updated record of current avatar ownership enables the player gaming devices 102 and/or the gaming server 104 to determine whether or not a player is permitted to perform actions associated with a given avatar, such as conduct automated gaming sessions. In other embodiments, rather than directly linking the avatar data 406 and/or the NFT identifier 412 to the player, the player may, within a gaming session, provide authentication data that verifies the player is associated with the blockchain address storing the avatar NFT. In such embodiments, the player gaming device 102 may present options to the player to verify avatar ownership (e.g., a prompt presented by the player gaming device 102 or a QR code presented by the player gaming device 102 to direct the player through an authentication process).

In the example embodiment, in response to the minting process of the avatar NFT, the gaming system 100 is configured to update the avatar to reflect the play style of the player. More specifically, the player gaming device 102 and/or the gaming server 104 are configured to collect game data 414 associated with one or more gaming sessions of the player. The game data 414 includes historical game actions performed by the player and the game conditions of each action (e.g., the player's credit balance, the player's hand, the dealer's hand, the actions of opposing players, etc.).

The gaming server 104 is configured to generate updated avatar parameters 416 at least partially as a function of the game data 414 and the current avatar parameters 408. That is, the game data 414 is treated as feedback, where the difference between each parameter of the original set 408 and the updated set 416 of avatar parameters is based on whether or not the game data 414 indicates the current parameters 408 substantially match or emulate the play style of the player. If a parameter 408 matches or is near to the play style of the player, then the corresponding updated parameter 416 may be the same or similar to the parameter 408. Conversely, if the game data 414 indicates the current parameter 408 is contrary or unlike the play style of the player, the change to the updated parameter 416 may be relatively large. It is to be understood that the determination of the updated game parameters 416 is adaptable for each parameter 416 and/or to suit the amount and type of game data 414 received. For example, not all parameters 408 may be updated in response to the game data 414 (e.g., a sufficient amount of training game data has been collected, or the parameter 408 has no corresponding game data 414). In another example, the updated parameters 416 may be determined additionally as a function of one or more weighted values that account for the amount of historical game data incorporated within the current parameters 408.

The updated avatar parameters are stored within the avatar database 106 for subsequent use as described herein. The updated avatar parameters 416 are generated and stored with a predefined or dynamic frequency. That is, the updated avatar parameters 416 may be generated periodically (e.g., every day or week), at the conclusion of every gaming session, and/or in response to player input. The updating of avatar parameters may be limited for a predetermined period of time (e.g., a training period or a period approved by the player) or available indefinitely while the player owns the avatar. In certain embodiments, historical avatar parameters are stored by the gaming server 104 and/or the avatar database 106 to facilitate rollback of avatar parameters if the updated parameters 416 produce an undesirable result.

In the example embodiment, the full functionality of the avatar is available to the player within a gaming session following a training period in which the avatar parameters are updated to sufficiently match or emulate the play style of the player. It is to be understood that “sufficiently match” in this context may be determined by the player providing feedback on the actions generated by the avatar and/or the system 100 determining the current parameters have meet a threshold comparison with the collected game data. In other embodiments, the full functionality may be available immediately following the minting process. The gaming system 100 may notify the player (e.g., via the player gaming device 102) when the training period is complete.

In the example embodiment, the avatars are configured to facilitate automated gaming sessions with the gaming system 100. That is, the player authorizes the avatar to participate in one or more games with a credit balance (or other resource balance for non-wagering games) without direct player intervention. The avatar, via the player gaming device 102 and/or the gaming server 104 generates automatic player actions 418 at least partially as a function of the updated avatar parameters 416 and the current state of a game within the automated gaming session. These automatic player actions 418 represent actions such as wagering, drawing cards, selecting dice, folding, and the like within the context of the particular game. In some embodiments, the automatic player actions 418 are generated and provided to game-logic circuitry for administering the game in a manner the same as manual player actions, thereby enabling automated gaming sessions without requiring customized interfaces for accepting avatar actions. In other embodiments, particularly embodiments in which avatar-only games are conducted, the input and processing of the automatic player actions 418 may be adapted to the processing speed of the participating devices (e.g., the player gaming devices 102 and/or the gaming server 104) relative to the speed of human play, thereby freeing processing resources to perform other actions of the gaming system 100.

The system 100 continues to generate and automatically perform the automatic player actions 418 through the automated gaming session. In the example embodiment, the automate gaming session includes one or more termination conditions, where the automated gaming session is concluded in response to detecting a termination condition and any remaining credit balance of the avatar is returned to the player. For example, one termination condition includes the credit balance of the avatar reaching a level insufficient to place a minimum wager for the current game. In another example, the player specifies one or more termination conditions when authorizing the automated gaming session, such as a number of rounds player, a credit balance value, and the like.

Through the automated gaming session, the player gaming device 102, the gaming server 104, and/or the avatar database 106 are configured to collect and store historical game data for the automated gaming session. The historical game data may be accessible by the player to, for example and without limitation, review the automated gaming session, provide feedback on certain automatic player actions 418, and/or watch highlights of the automated gaming session. In certain embodiments, based on the feedback of the player, the historical game data of the automated gaming session may be used similar to the game data 414 to update the avatar parameters 416.

In some embodiments, in addition to or alternative to the automated gaming sessions, the automatic player actions 418 are available for other suitable functions of the gaming system 100. In one example, the avatar notifies the player if they are deviating from their historical play style during a gaming session. In another example, the automatic player actions 418 may be provided to the player as a recommended action, where the player can accept the recommendation, perform an action based on the recommendation, or altogether ignore the recommendation. In a further example, the avatar may be available to participate in a training game as an opposing player.

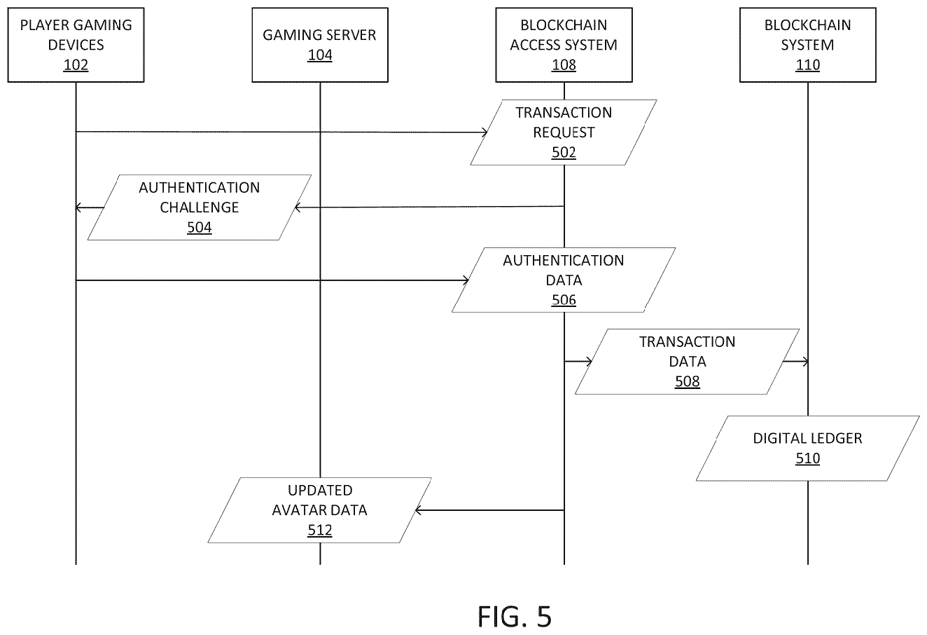

FIG. 5 depicts an example data flow diagram for trading, renting, or otherwise transacting an avatar between players using the gaming system 100 (shown in FIG. 1). Similar to FIG. 4, the data flow of FIG. 5 is for exemplary purposes only and is not intended to limit the present disclosure to the particular configuration and flow of data described herein. For example, the same data of FIG. 5 may be communicated to additional or alternative recipients (including recipients external to the system 100) to achieve the same or similar functionality as described herein. In some embodiments, the process described herein includes additional, fewer, or alternative data elements, including those described elsewhere herein.

In the example embodiment, an avatar transaction is initiated through the player gaming devices 102. In other embodiments, other suitable devices (e.g., personal player devices not within the system 100) are used to initiate the avatar transaction. The avatar transaction is a transaction in which ownership of an avatar is changed (at least temporarily for rentals). Ownership of the avatar determines what, if any, actions associated with the avatar are permitted by a given player. The ownership of the avatar within the gaming system 100 is determined by the owner of the NFT associated with the avatar.

In the example embodiment, the sending player and/or receiving player transmit a transaction request 502 to the blockchain access system 108 for the avatar transaction. The transaction request 502 includes identifying data, such as the blockchain address of each party and the NFT to be transferred, to facilitate the transaction. In at least some embodiments, the transaction request includes authentication data to authenticate the identity of each party and authorize the transaction. However, in the illustrated embodiment, no authentication data is preemptively provided, and the blockchain access system 108 generates and transmits an authentication challenge 504 to the sending player and/or receiving player. The authentication challenge may be at least partially based on the transaction request, data stored by the avatar database 106 (shown in FIG. 1), and/or data stored by the blockchain system 110.

The authentication challenge 504 also acts as authorization request, where responding to the authentication challenge successfully also indicates the approval of the sending player and/or the receiving player of the transaction. In some embodiments, authentication and authorization are performed separately. For example, if the transaction request 502 includes authentication data, then no authentication challenge 504 is sent to the players, but instead an authorization request may be sent.

In response to the authentication challenge 504, the player and/or the player gaming device 102 provide authentication data 506 to the blockchain access system 108. The type of authentication data 506 is based on the challenge 504. For example, the authentication challenge 504 may request a digital signature, biometric data, password, and/or other suitable data associated with the player, and the authentication data 506 corresponds to the requested type or types of data. The authentication data 506 may be manually provided by the player and/or automatic provided by the player gaming device 102.

The authentication data 506 is compared to stored authenticated data by the blockchain access system 108 to verify the authenticity of both players. If the players are authenticated (i.e., the stored authenticated data substantially matches the authentication data 506), the transaction continues. If one or both players fail the authentication challenge 504 based on the comparison, the transaction is blocked, and the gaming system 100 may be configured to determine if fraudulent activity is occurring and/or notify an administration party of the failed transaction.

In the example embodiment, the authenticated and authorized transaction is initiated by the blockchain access system 108 providing transaction data 508 to the blockchain system 110. The transaction data 508 includes the blockchain addresses of the sending and receiving players and the NFT identifier. The transaction data 508 may also include input data for any smart contract incorporated within the NFT. For example, for a rental transaction, the transaction data 508 may include input data that activates a rental smart contract, where the avatar NFT is transacted back to the sending player automatically after a period of time.

The transaction data 508 received by the blockchain system 110 is incorporated into a transaction to be stored on a digital ledger 510 of the blockchain. The digital ledger 510 include a historical and immutable record of transactions within a given blockchain. Each blockchain node is configured to maintain a separate copy of the digital ledger 510, and the transaction is published to the digital ledger 510 by circulating the transaction data 508 to a plurality of the blockchain nodes and publishing the transaction to the next block of the blockchain. The blockchain system 110 is configured to notify the blockchain access system 108 of the successful transaction and/or the blockchain access system 108 monitors new blocks of the blockchain for the transaction.

In other embodiments, the data flow described above may be at least partially performed external to the gaming system 100. For example, the blockchain system 110 may be accessible by the players through external devices, and the blockchain system 110 may be configured to authenticate, authorize, and/or publish the transaction. In certain embodiments, the system 100, via the blockchain access system 108 is a required third party to the transaction that has authority to selectively authorize transaction requests. In such embodiments, the transaction data 508 includes authorization data from the blockchain access system 108.

In response to verifying the successful transaction, the blockchain access system 108 notifies the players and the gaming server 104. The gaming server 104 or the blockchain access system 108 updates the avatar data 512 stored within the avatar database 106 to reflect the current ownership of the avatar. Accordingly, the sending player has limited or no access to actions associated with the avatar while said actions are made available to the receiving player.

In at least some embodiments, the receiving player may use the avatar to perform training sessions (either for the avatar or the player) and/or participate in regular or automated gaming sessions. An avatar may include one or more metrics, statistics, or rankings that define a relative skill or performance of the avatar. These values may be based on the performance of the avatar in automated gaming sessions, the performance of the player or players corresponding to the avatar (e.g., the sending player), or combinations thereof. The performance metrics or rankings of the avatar may be used in competitive matchmaking within the gaming session, wherein the matchmaking determines the competitive level of the player based at least in part on the corresponding avatar. For regular gaming sessions, the matchmaking may be based on both the player's ranking and the avatar's ranking, while automated gaming sessions are based on the avatar's ranking. In certain embodiments, the avatar may be used to gain access to tournaments and games that extend beyond the player's current ranking.

In at least some embodiments, to facilitate the transactions described in FIG. 5, the gaming system 100 is configured to provide a marketplace for players to sell and purchase avatars. The marketplace may be hosted by the gaming server 104 and/or the blockchain access system 108 through one or more interfaces that facilitate linking sellers to buyers of avatars. Other suitable items or services associated with the gaming system 100, such as cosmetic items for the avatars, may be purchasable through the marketplace. At least a portion of the transaction request 502 may be generated in response to interactions within the marketplace. In other embodiments, the transaction is conducted external to the gaming system 100 (i.e., directly through the blockchain system 110), and the marketplace is simply configured to provide information to prospective buyers and sellers of avatars.

Described herein are embodiments of devices, systems, and the like that may be incorporated within the gaming system 100 to facilitate the functions described above. It is to be understood that other devices, interfaces, data, and the like beyond the following embodiments described herein are considered within the spirit and scope of the present disclosure, including those described elsewhere herein.

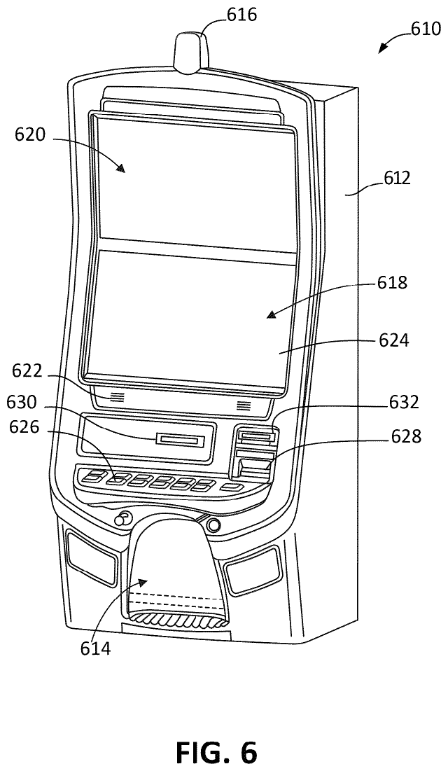

Referring to FIG. 6, there is shown a gaming machine 10 (i.e., a player gaming device) similar to those operated in gaming establishments, such as casinos. With regard to the present invention, the gaming machine 610 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 610 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 610 illustrated in FIG. 6 comprises a gaming cabinet 612 that securely houses various input devices, output devices, input/output devices, internal electronic/electromechanical components, and wiring. The cabinet 612 includes exterior walls, interior walls and shelves for mounting the internal components and managing the wiring, and one or more front doors that are locked and require a physical or electronic key to gain access to the interior compartment of the cabinet 12 behind the locked door. The cabinet 612 forms an alcove 614 configured to store one or more beverages or personal items of a player. A notification mechanism 616, such as a candle or tower light, is mounted to the top of the cabinet 612. It flashes to alert an attendant that change is needed, a hand pay is requested, or there is a potential problem with the gaming machine 610.

The input devices, output devices, and input/output devices are disposed on, and securely coupled to, the cabinet 612. By way of example, the output devices include a primary presentation device 618, a secondary presentation device 620, and one or more audio speakers 622. The primary presentation device 618 or the secondary presentation device 620 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 618, 620, the audio speakers 622, lighting assemblies, and/or other devices associated with presentation are collectively referred to as a “presentation assembly” of the gaming machine 610. The presentation assembly may include one presentation device (e.g., the primary presentation device 618), some of the presentation devices of the gaming machine 610, or all of the presentation devices of the gaming machine 610. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 618 and/or the secondary presentation device 620, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 610. The gaming machine 610 may include a touch screen(s) 624 mounted over the primary or secondary presentation devices, buttons 626 on a button panel, a bill/ticket acceptor 628, a card reader/writer 630, a ticket dispenser 632, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 624, buttons 626, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The gaming machine 610 includes one or more value input/payment devices and value output/payout devices. In order to deposit cash or credits onto the gaming machine 610, the value input devices are configured to detect a physical item associated with a monetary value that establishes a credit balance on a credit meter. The physical item may, for example, be currency bills, coins, tickets, vouchers, coupons, cards, and/or computer-readable storage mediums. The deposited cash or credits are used to fund wagers placed on the wagering game played via the gaming machine 610. Examples of value input devices include, but are not limited to, a coin acceptor, the bill/ticket acceptor 628, the card reader/writer 630, a wireless communication interface for reading cash or credit data from a nearby mobile device, and a network interface for withdrawing cash or credits from a remote account via an electronic funds transfer. In response to a cashout input that initiates a payout from the credit balance on a “credits” meter, the value output devices are used to dispense cash or credits from the gaming machine 610. The credits may be exchanged for cash at, for example, a cashier or redemption station. Examples of value output devices include, but are not limited to, a coin hopper for dispensing coins or tokens, a bill dispenser, the card reader/writer 630, the ticket dispenser 632 for printing tickets redeemable for cash or credits, a wireless communication interface for transmitting cash or credit data to a nearby mobile device, and a network interface for depositing cash or credits to a remote account via an electronic funds transfer.

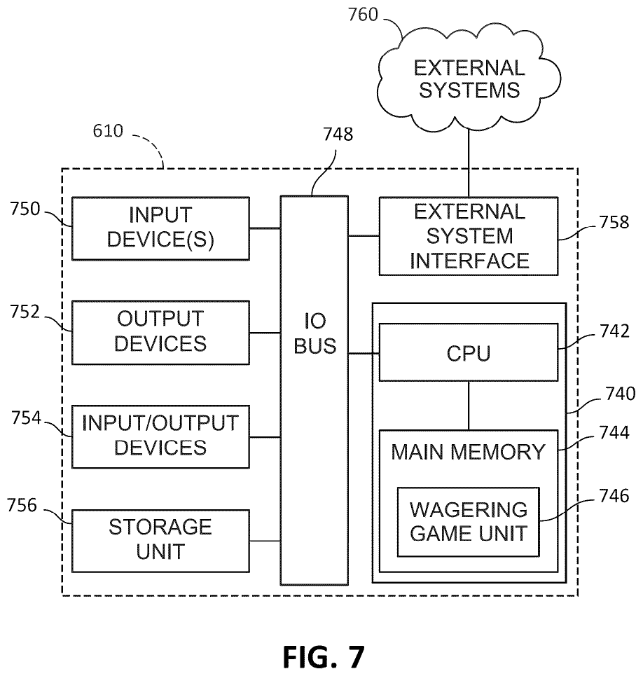

Turning now to FIG. 7, there is shown a block diagram of the gaming-machine architecture. The gaming machine 610 includes game-logic circuitry 740 securely housed within a locked box inside the gaming cabinet 612 (see FIG. 6). The game-logic circuitry 740 includes a central processing unit (CPU) 742 connected to a main memory 744 that comprises one or more memory devices. The CPU 742 includes any suitable processor(s), such as those made by Intel and AMD. By way of example, the CPU 742 includes a plurality of microprocessors including a master processor, a slave processor, and a secondary or parallel processor. Game-logic circuitry 740, as used herein, comprises any combination of hardware, software, or firmware disposed in or outside of the gaming machine 610 that is configured to communicate with or control the transfer of data between the gaming machine 610 and a bus, another computer, processor, device, service, or network. The game-logic circuitry 740, and more specifically the CPU 742, comprises one or more controllers or processors and such one or more controllers or processors need not be disposed proximal to one another and may be located in different devices or in different locations. The game-logic circuitry 740, and more specifically the main memory 744, comprises one or more memory devices which need not be disposed proximal to one another and may be located in different devices or in different locations. The game-logic circuitry 740 is operable to execute all of the various gaming methods and other processes disclosed herein. The main memory 744 includes a wagering-game unit 746. In one embodiment, the wagering-game unit 746 causes wagering games to be presented, such as video poker, video blackjack, video slots, video lottery, etc., in whole or part.

The game-logic circuitry 740 is also connected to an input/output (I/O) bus 748, which can include any suitable bus technologies, such as an AGTL+ frontside bus and a PCI backside bus. The I/O bus 748 is connected to various input devices 750, output devices 752, and input/output devices 754 such as those discussed above in connection with FIG. 6. The I/O bus 748 is also connected to a storage unit 756 and an external-system interface 758, which is connected to external system(s) 760 (e.g., the devices of the gaming system 100, shown in FIG. 1).

The external system 760 includes, in various aspects, a gaming network, other gaming machines or terminals, a gaming server, a remote controller, communications hardware, or a variety of other interfaced systems or components, in any combination. In yet other aspects, the external system 760 comprises a player's portable electronic device (e.g., cellular phone, electronic wallet, etc.) and the external-system interface 758 is configured to facilitate wireless communication and data transfer between the portable electronic device and the gaming machine 610, such as by a near-field communication path operating via magnetic-field induction or a frequency-hopping spread spectrum RF signals (e.g., Bluetooth, etc.).

The gaming machine 610 optionally communicates with the external system 60 such that the gaming machine 610 operates as a thin, thick, or intermediate client. The game-logic circuitry 740—whether located within (“thick client”), external to (“thin client”), or distributed both within and external to (“intermediate client”) the gaming machine 610—is utilized to provide a wagering game on the gaming machine 610. In general, the main memory 744 stores programming for a random number generator (RNG), game-outcome logic, and game assets (e.g., art, sound, etc.)—all of which obtained regulatory approval from a gaming control board or commission and are verified by a trusted authentication program in the main memory 744 prior to game execution. The authentication program generates a live authentication code (e.g., digital signature or hash) from the memory contents and compare it to a trusted code stored in the main memory 744. If the codes match, authentication is deemed a success and the game is permitted to execute. If, however, the codes do not match, authentication is deemed a failure that must be corrected prior to game execution. Without this predictable and repeatable authentication, the gaming machine 610, external system 760, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 742 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 742 when executing the game-outcome logic to determine a resultant outcome for that instance of the wagering game. The resultant outcome is then presented to a player of the gaming machine 610 by accessing the associated game assets, required for the resultant outcome, from the main memory 744. The CPU 742 causes the game assets to be presented to the player as outputs from the gaming machine 610 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 610 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 610 may include additional peripheral devices or more than one of each component shown in FIG. 7. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 610 depicted in FIG. 6, following receipt of an input from the player to initiate a wagering-game instance. The gaming machine 610 then communicates the wagering-game outcome to the player via one or more output devices (e.g., primary presentation device 618 or secondary presentation device 620) through the presentation of information such as, but not limited to, text, graphics, static images, moving images, etc., or any combination thereof. In accord with the method of conducting the wagering game, the game-logic circuitry 740 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 740 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 742 causes the recording of a digital representation of the wager in one or more storage media (e.g., storage unit 756), the CPU 742, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 742 (e.g., the wager in the present example). As another example, the CPU 742 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 740 to determine the outcome of the wagering-game instance. In at least some aspects, the game-logic circuitry 740 is configured to determine an outcome of the wagering-game instance at least partially in response to the random parameter.

In one embodiment, the gaming machine 610 and, additionally or alternatively, the external system 760 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be implemented with hardware and software architectures, circuitry, and other special features that differentiate it from general-purpose computers (e.g., desktop PCs, laptops, and tablets).

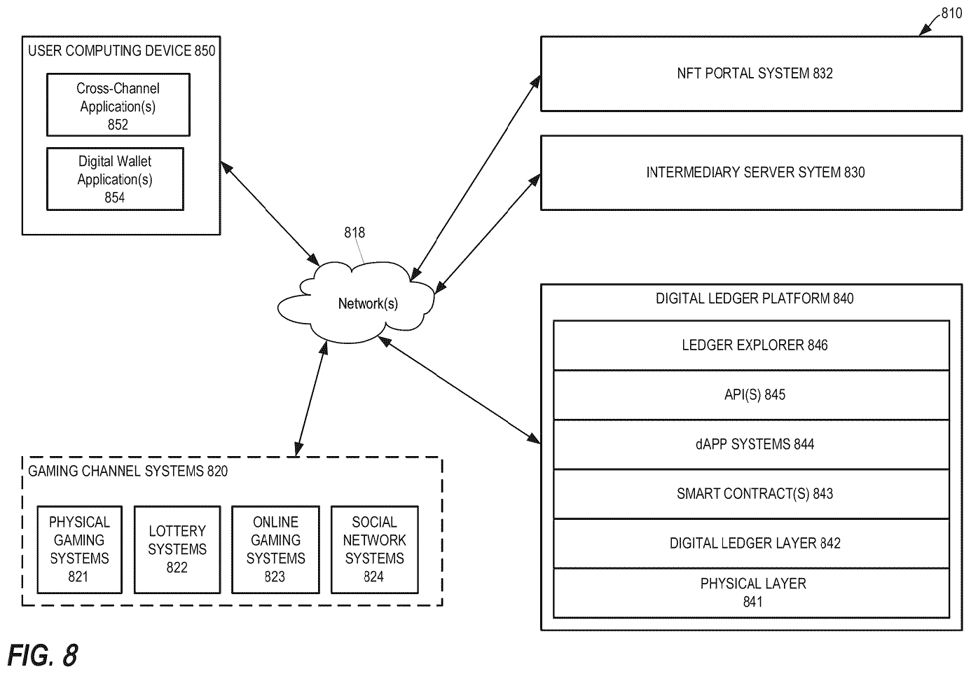

FIG. 8 depicts a block diagram of an example computing environment 810 that can be used to implement one or more embodiments of the present disclosure. The computing environment 810 includes a plurality of computing devices that are communicatively coupled over one or more networks 818. In this example, the computing devices include one or more gaming channel systems 20, an intermediary server system 830, a non-fungible token (NFT) portal system 832, a digital ledger platform 840, and a user computing device 850. Although shown separately, various elements of FIG. 8 may be combined. For example, the NFT portal system 832, intermediary server system 830, and/or dApp systems 860 can be part of the digital ledger platform 840 in example embodiments. Computing environment 810 is one example of a computer gaming environment. The number and type of computing devices in the computing systems of FIG. 8 are depicted by way of example only. For example, other computing environments may include additional user computing devices 850, fewer or additional gaming channel systems 820, etc. than those depicted in FIG. 8. It will be appreciated that the system of FIG. 8 is provided by way of example and not limitation as other computing systems may be used in accordance with example embodiments of the present disclosure.

The user computing device 850 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

Gaming channel systems 820 include a physical gaming system 21, a lottery system 822, an online gaming system 823, and a social network system 824. The number and type of gaming systems in FIG. 8 is provided by way of example only. For example, physical gaming systems 821 may represent a single electronic gaming machine (EGM) at a gaming location or multiple EGM's and/or associated computing devices such as one or more physical gaming servers that support the EGMs or client devices. Lottery system 822 may represent a single point-of-sale device for distributing lottery tickets and/or additional lottery devices such as servers supporting the lottery POS devices and client devices. Online gaming system 823 may represent a user device running an online game or an online gaming system 823 supporting the game for gameplay on a user device. Social network system 824 may represent a user device executing a local client application and/or server device providing an online social network service. In some example embodiments, the various gaming channel devices may be under control and operation by a single entity such as a gaming operator. In other examples, the gaming channel systems 820 may be under the control of multiple different entities. For example, a first gaming entity may operate a physical gaming server while a different gaming entity may operate a lottery server or online gaming server.

Digital ledger platform 840 can include one or more computing devices that provide a digital ledger infrastructure in association with gaming channel systems 820. Digital ledger platform 40 enables numerous different non-fungible tokens (NFT) to be actioned across one or more of the gaming channel systems 820. Moreover, digital ledger platform 840 supports cross-channel actioning of NFTs to enable NFTs to be used in and across different gaming channels. Digital ledger platform 840 includes a physical layer 841 comprising one or more computing devices (e.g., a server system, distributed peer-to-peer network, etc.), a digital ledger layer 842 comprising one or more digital ledgers, one or more smart contracts 843, distributed application (dAPP) systems 844, an API layer comprising one or more APIs 845 for accessing elements of the ledger platform such as smart contracts 843, and a ledger explorer 846.

A digital ledger, as that term is used herein, refers to all forms of electronic, computer-based, distributed ledgers. Examples of digital ledgers include consensus-based blockchain and transaction-chain technologies, permissioned and un-permissioned ledgers, shared ledgers and variations thereof. A blockchain is a peer-to-peer, digital ledger implemented as a decentralized, distributed computer-implemented system. A blockchain architecture enables different users to make transactions and creates an unchangeable record of those transactions. A network of computing nodes must first agree that a transaction is valid in order to move anything of value over any kind of blockchain. In this manner, a blockchain can operate as a peer-to-peer network. A blockchain ledger can be combined with a distributed time-stamp server so that the blockchain ledger can be managed autonomously to exchange information between different parties.

A blockchain is a write-once, append-many type of electronic ledger comprised of blocks which, in turn, are comprised of transactions. Each transaction includes at least one input and at least one output. A transaction is a data structure that encrypts or otherwise encodes the transfer of ownership or control of a digital asset between participants in the blockchain. Each block in a blockchain contains a hash of the previous block in the blockchain. In this manner, the blocks of a blockchain are chained together to create a permanent record of all transactions which have been written to the blockchain since its inception. This record cannot be altered without detection due to linking of blocks by hashing. Transactions contain small programs or scripts embedded into the inputs and outputs. A transaction script specifies how and by whom the outputs of the transactions can be accessed.

Blockchain transactions can be represented as messages that can be transported between computing nodes using a network (e.g., network 818) for example. A digest of a transaction may be made available to one or more computing systems to make elements of a system aware of the existence of a transaction, and to provide a way to check the integrity of messages containing full transactions. This enables complete and efficient propagation of incoming transaction messages to the appropriate elements. It also reduces the network loading associated with traditional protocols and provides protection. Other examples of recording and making a transaction available may be used.

Transactions are validated before being written to the blockchain. Network nodes, also referred to as miners, perform algorithmic work to determine whether a transaction is valid, and reject invalid transactions from the network. Transactions are validated by a first node in the network, relayed to other nodes in the network upon validation, added to a new block built by a miner, and then “mined” by being added to the public ledger of past transactions.

According to example aspect of the present disclosure, the network nodes can comprise at least a portion of physical layer 841 which stores the data and/or performs functions of the digital ledger platform 840 as described herein. Notably, the digital ledger platform can be implemented with a distributed architecture with distributed computing systems. As such, the network nodes can be implemented by any computing device within the computing environment. For instance, any computing device such as a computing device as part of a gaming channel system can act as a node within the computer network. In some examples, a network node can be a partial network node that has limited or reduced functionality relative to other nodes. For instance, a partial network node may have read-only capabilities. In some examples, third party nodes are not relied upon for conveying data relating to the blockchains. A single party may control the digital ledger platform or portions thereof without third party nodes conveying data such as NFT data.

A digital ledger layer 842 of the digital ledger platform 40 may be used for the implementation of or otherwise in association with one or more smart contracts 43. By way of example, the digital ledger platform 840 may provide one or more virtual machines hosted by the physical layer 841 that are configured to generate and/or manage smart contracts. A smart contract 843 is a computer program that automates the execution of the terms of a machine-readable contract or agreement. A smart contract is a machine executable program including rules that process inputs in order to produce results. The results of processed inputs can cause actions to be performed dependent upon those results. By way of example, a commercial transaction may involve the transfer of property rights and/or assets. Such assets may include real property, personal property including both tangible and intangible property, digital assets such as software, for example, or any other type of asset. Smart contracts can provide enhanced control, efficiency, and speed of transfer for these transactions.

Smart contracts 843 can be written to one or more blockchains of the digital ledger layer 42 such that the smart contracts 843 are immutable. The inputs to a smart contract can be formatted to include the data structures defined by the blockchain. A smart contract can accept inputs extracted from the transactions within the digital ledgers to automatically perform one or more predefined functions.

By way of example, a smart contract may be used to determine whether pre-determined conditions are met that prove an entity owns an NFT and has authority to transfer ownership. Smart contracts may require one or more sets of inputs to trigger a transaction. The inputs can be formatted to include data structures defined by the blockchain. The smart contracts can accept inputs extracted from transactions within the digital ledgers. A smart contract may be written in any suitable programming language, such as various programming languages based on If-This-Then-That (IFTTT) logic. A smart contract can be published or otherwise employed to enable cross-channel NFT actions as described herein.

A token within the digital ledger platform 40 can be used to represent and transfer assets via a digital ledger. A token can identify a real-world digital item or asset to be referenced from the digital ledger. Tokens may be fungible or non-fungible. A fungible unit is equivalent to and interchangeable with other units of the same commodity. Fungible tokens (FTs) are tokens that can be exchanged for any other token with the same value. A token can have various potential formats such as unique character string, a value, a pointer, an address, etc. A token can include an identifier such as an address or link to information maintained in non-volatile storage.

Nonfungible tokens (NFTs) are not replaceable with other tokens of the same type. NFTs represent nonfungible assets. Nonfungible assets have unique information or attributes. Each NFT is unique and differs from other tokens of the same class. For example, two concert tickets may appear similar, but each may have attributes or properties that render it irreplaceable by another concert ticket. Each concert ticket may have a different seat number and date which causes it to be unique from other concert tickets. Additionally, NFTs cannot be divided as the elementary unit of the NFT is the token itself.

Intermediary server system 830 includes one or more computing devices that communicate with digital ledger platform 840 and gaming channel systems 20 to enable token services across the various gaming channels. In some embodiments, the intermediary server system 830 may include one or more computing devices operating within the physical layer 841 of the digital ledger platform 840. For example, intermediary server system 830 may include one or more nodes of the physical layer 41. In another example, intermediary server system 830 may include a partial node of the digital ledger platform. A “partial node” in this context is a computing device that monitors at least some transactions within the digital ledger platform but does not verify or authenticate the monitored transactions through mining. NFT portal system 832 includes one or more computing devices that provide an access point to NFTs provided by the gaming system. For example, a user can use a user computing device 850 to access a website or application hosted by the NFT portal system 832 in order to purchase, sell, or otherwise engage in transactions in association with NFTs provided by the gaming system. NFT portal system 832 may connect to digital ledger platform 840 over one or more communication channels which may be secured using authentication and/or encryption. In some examples, NFT portal system 832 can access one or more APIs to read data from the digital ledger platform.

By way of example, a player may access a first gaming channel such as a physical electronic gaming machine (EGM). The player may pair a cross-channel application 852 with the EGM in some examples. The player may interact with the EGM and receive an NFT through such interaction (e.g., as a reward or purchase). The NFT can be recorded on a blockchain of the digital ledger platform 840. Later, the user may access another gaming channel such as an online gaming system and use the NFT for rewards through the online gaming system. Alternatively, the user may sell the NFT to another player through the online gaming system. Similarly, the user may access NFT portal system 832 and sell the NFT to another player.

Computing environment 810 further includes one or more distributed application (dApp) systems 860 that run on one or more decentralized networks rather than a typical centralized server. In example embodiments, a dApp can execute on a decentralized network while using a digital ledger to store data associated with the dApp and a smart contract 843 that defines the logic of the dApp. Once deployed on the digital ledger platform 840, a dApp cannot be changed and executes according to the logic defined by the smart contract 843. A computing node in the digital ledger platform can execute one or more decentralized applications via a smart contract 843 in example embodiments.

The network 818 can be any type of communications network, such as a local area network (e.g., intranet), wide area network (e.g., Internet), or some combination thereof and can include any number of wired or wireless links. In general, communication over the network 818 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

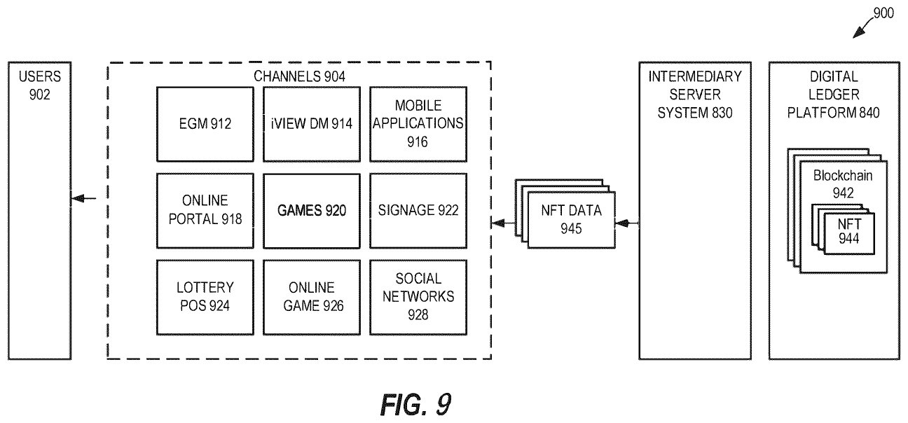

FIG. 9 is a block diagram depicting an example gaming computing environment 900 in which a set of non-fungible tokens 944 (NFTs 944) are actioned by intermediary server system 830 for a plurality of users 902 via a plurality of gaming channels 904 according to an example embodiment of the present disclosure. In this example, the digital ledger platform 40 includes one or more blockchains 942 (e.g., hosted by the digital ledger layer on the physical layer), each including blocks chained together to form an unchangeable record of all transactions written to the blockchain 942. NFTs 944 can be minted on a blockchain 942 as a result of or otherwise in response to validation of a transaction by at least one computing node. According to example aspects of the disclosed technology, private and/or public blockchains 942 may be provided by digital ledger platform 840. A blockchain 942 of the ledger infrastructure may be used to record transactions relating to NFTs 944 which are actioned by the intermediary server system 830 to users via channels 904. In this manner, the NFTs can be managed by the intermediary server system 830 using the digital ledger platform 840 to provide secure public transactions.

By way of example, NFTs may be used to record or otherwise represent virtual objects. Such virtual objects include, but are not limited to, avatars, audio clips, game symbols, trump cards, spaces in games, badges, characters, moments, backgrounds bonus and other digital features or elements associated with gameplay. An NFT 944 may be recorded on a blockchain that points to the digital content. For example, traditional location addressing or content addressing may be used to link an NFT with content that it represents. In certain examples, the NFT 944 may point to another distributed and/or decentralized data storage system configured to store data at a relatively larger scale than the blockchain 942, such as the InterPlanetary File System (IPFS) and the like. In some examples, at least a portion of the digital content can be stored in the NFT itself. The digital content may be stored in an encoded format such that retrieval of the digital content from a blockchain includes decoding the digital content for use with the channels 904. Other examples of NFTs include rewards, skins, virtual items such as tools, cars, clothing etc., game payouts, game levels, skill levels, a moment in a game from which play may begin, and other items, elements, objects, and the like relating to games. The NFTs may be recorded on the blockchain 942 along with any transactions relating to the NFT. In this manner, a transparent ability to establish and track ownership of any virtual item can be provided.

A blockchain 942 can provide a chronological recording of all transactions relating to a particular NFT 944. This recording can be stored in a blockchain 942 that can be distributed across multiple nodes in the blockchain network of platform 840. Each node can store a copy of the transaction or code, which is accessed and updated in a decentralized manner.

In addition to securing and providing transparency for NFT transactions between players, the use of a blockchain 942 enables third parties such as tax collectors, auditors, government officials, or other parties to access and view transactions related to the blockchain. In some examples, third parties may use one or more distributed applications (dApps) as shown in FIG. 1 to access a blockchain to view details related to NFT transactions.

A non-fungible token 944 (NFT 944) can be actioned to a user 902 via any one of the example gaming channels depicted in FIG. 9. In the example of FIG. 9, an NFT can be actioned to a user 902 by providing NFT data 945 (e.g., data stored on the blockchain with the NFT, or data associated with the NFT by one or more identifiers, pointers, and/or addresses stored with the NFT) associated with a particular NFT on the blockchain to an electronic gaming machine (EGM) 912 or an integrated view display manager 914 such as iView DM that enables a video display of a gaming machine to display customized marketing or other content directly at a point of play. The NFT data 945 can be used to provide a personalized NFT experience at the point of play. For instance, the intermediary server system 30 can access digital content of an NFT, such as a character or virtual item, and provide the digital content to the appropriate gameplay channel for display. In another example, NFT data 945 may identify a gameplay level, particular game, or other feature that will be presented to the player based on the NFT.

As yet another example, an NFT can be sold or awarded to a user during gameplay associated with the EGM or iView DM 914. A new block can be created on the blockchain to identify a digital wallet or cross-channel application 852 of the new owner as described in FIG. 8. The transfer of control of the NFT 944 to the user 902 can be recorded as a transaction in a blockchain 942. In some examples, the identifying information for the user recorded in the blockchain for the transaction is a public key of a public key/private key pair. In this manner, the user's privacy may be maintained while facilitating traceable transactions within the blockchain infrastructure.

In another example, an NFT can be actioned to a user directly via a mobile application 916 such as a gaming application executed by a mobile device. A player may be awarded or purchase an NFT during gameplay associated with the mobile application. An NFT can also be actioned to a user 902 via an online portal 918 such as NFT portal system 832 in FIG. 8. NFTs can also be actioned to a user 902 via games 920, signage 922, lottery system 924, online games 926, and social networks 928.

Any transaction involving an NFT 944 can be recorded on a blockchain within digital ledger platform 840. A transaction can be validated, then recorded on the distributed blockchain. In example embodiments, the information recorded for a transaction may include identifying information (e.g., a public key) for the providing and receiving parties, an identification of the gaming channel involved in the transaction, any smart contract actions performed as a result of the transfer (e.g., transfer of funds between a digital wallet of a purchaser and a digital wallet of a seller), or other pertinent information relating to the transaction. The transaction can be stored as a block within the blockchain in example embodiments.

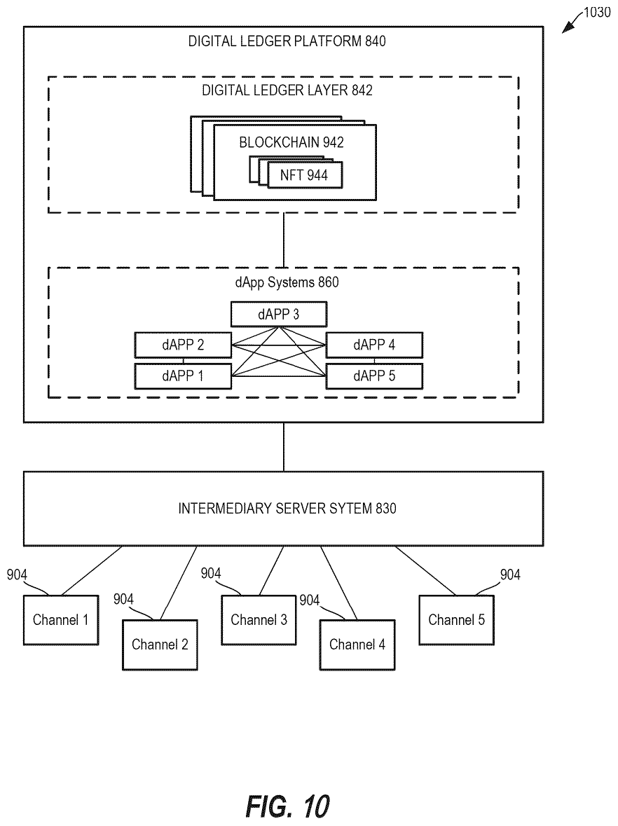

FIG. 10 is a block diagram depicting an example distributed architecture of a computing gaming environment 1030 in accordance with an example embodiment of the present disclosure. Computing gaming environment 1030 includes digital ledger platform 840 having a digital ledger layer 842 and a layer of distributed applications within dApp Systems 860. In this particular example, five distributed applications dAPP1, dAPP2, dAPP3, dAPP4, and dAPP5 are provided although it will be appreciated that any number and type of distributed applications may be included in various examples. Computing gaming environment 1030 further includes intermediary server system 830 which communicates with the digital ledger platform 840 and gaming channels 904. Five gaming channels 904 are provided by way of example. It will be appreciated that any number and type of gaming channels may be included in various examples.

The dAPP systems 860 of the distributed computing environment provide a bridge between the distributed architecture of the digital ledger platform 840 and the different gaming channels 904. Intermediary server system 830 is disposed between the gaming channels and the distributed digital ledger platform 840 to provide a number of improvements over typical gaming systems.

Traditionally, gaming systems such as games that involve monetary wagers, have required strict security requirements and adherence to various regulations. As such, centralized gaming architectures are often utilized to provide closed solutions that enable strict oversight for security and regulatory compliance. While blockchains and other digital ledger architectures are inherently safe and provide improved security, there are many unique elements within gaming architectures to be considered and addressed so that security and regulatory compliance can be provided.

According to an example aspect of the present disclosure, an intermediary server system is provided that can provide an intermediate bridge between a decentralized blockchain architecture and currently approved centralized gaming solutions which are gaming compliant. Intermediary server system 830 can provide abstraction, isolation, security, and gaming compliance as may be required for a gaming system, while also enabling the gaming system to fully leverage the benefits of the decentralized blockchain architecture. By way of example, the intermediary server system 830 can provide firewalls and safety and security solutions to ensure that gaming integrity is maintained in the gaming systems.

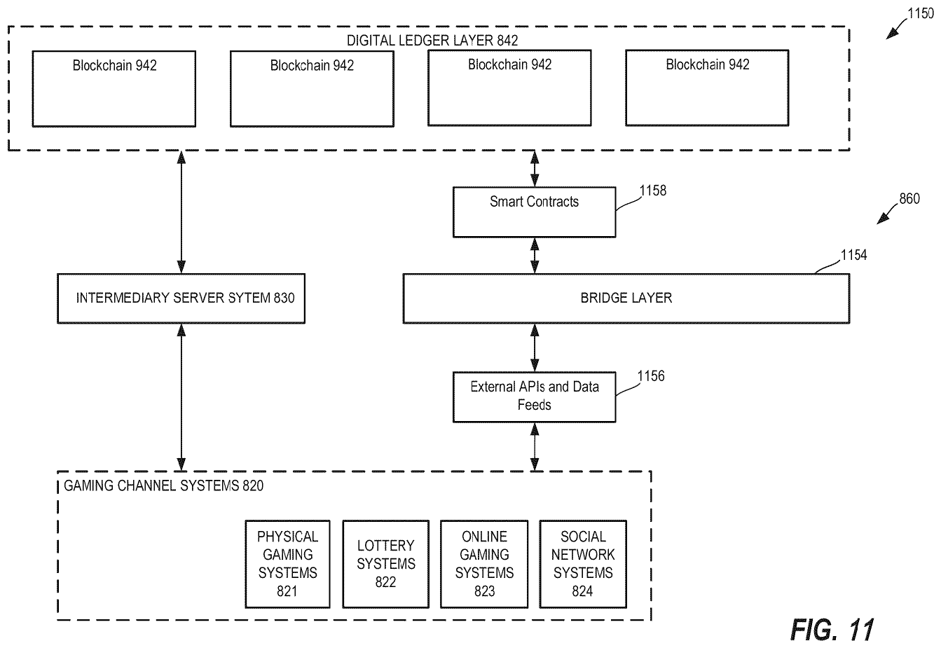

FIG. 11 is a block diagram depicting an intermediary server architecture of a gaming computing environment 1150 in accordance with an example aspect of the present disclosure. Gaming computing environment 1150 includes digital ledger layer 842 having a plurality of blockchains 942 and gaming channel systems 820 such as physical gaming systems 821, lottery systems 822, online gaming systems 823, and social network systems 824.

Intermediary server system 830 is in communication with gaming channel systems 20 and digital ledger layer 842 to provide an intermediate bridge between the two. By way of example, intermediary server system 830 can action NFTs on a blockchain 942 to one or more gaming systems. Intermediary server system 830 can include one or more server and/or other types of computing devices. For instance, intermediary server system 830 can provide an NFT or data associated with an NFT (NFT data) to a gaming system. As an example, intermediary server system 830 can apply an NFT such as an avatar to a particular gaming system in response to a user pairing a cross-channel application with the gaming system. By way of example, intermediary server system 830 may decode data associated with an NFT and/or format the data for use within a particular gaming channel.

Bridge layer 1154 provides a further bridge between gaming systems and digital ledger layer 842. Bridge layer 1154 can provide external APIs and data feeds 1156 that enable gaming channel systems 820 to communicate with the digital ledger layer. Bridge layer 1154 may include one or more distributed applications such as an oracle application (e.g., Chainlink) and/or one or more distributed application networks such as an oracle network. The bridge layer may include one or a plurality of nodes. Bridge layer 1154 can further provide smart contracts 1158 in association with one or more blockchains 942.

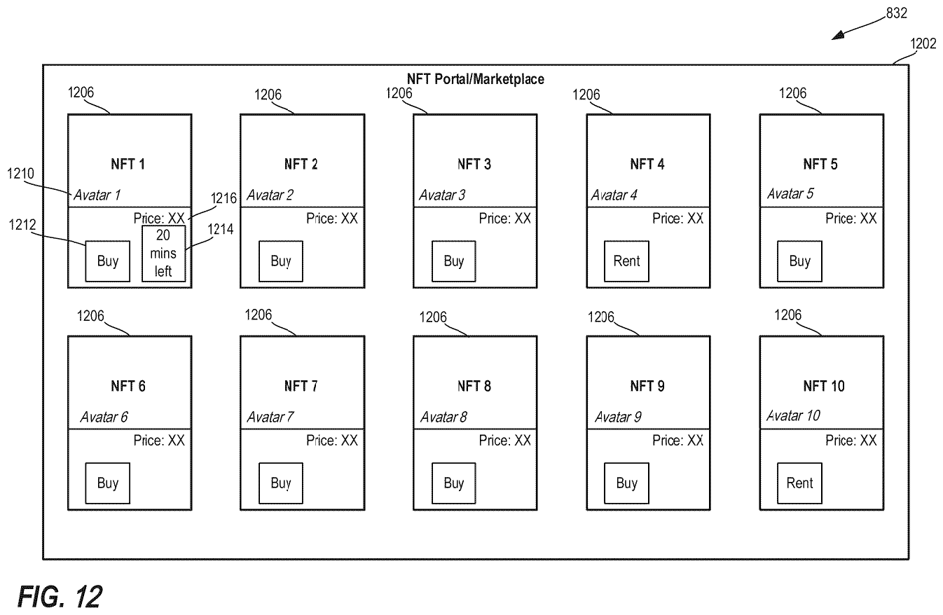

FIG. 12 illustrates an example graphical user interface 1202 that may be provided by an NFT portal system 832 in accordance with example embodiments of the present disclosure. In this particular example, a particular graphical user interface 1202 is provided for an NFT Portal/Marketplace. Graphical user interface 1202 (GUI 1202) enables a user to perform various actions relating to a subset of NFTs within the gaming system. The example interface depicts ten non-fungible tokens (NFTs) 1206 that may be actioned by a player. The player may access the NFT portal system 32 and GUI 1202 via a cross-channel application 852 in example embodiments. In other embodiments, a player may access the NFT portal and GUI 1202 via another gaming channel such as through an iView interface or online game.

NFTs 1206 may include any type of NFT described herein. For instance, NFT's may represent characters with the gaming system. For example, each character may be a game piece within a game or a collectible within a game. It will be appreciated that similar NFTs such as badges, skins, and the like may similarly be represented in a GUI. Each NFT 1206 depiction can include identifying attribute information 1210 in some examples. The NFT may include an address (either location or content address) to identify the associated digital asset in an external data storage system (e.g., the avatar database 106, shown in FIG. 1). For instance, an NFT may include attribute information 1210 that describes attributes of a character, etc. Each NFT further includes a Price 1216 for purchasing or performing another action relative to the NFT. Each NFT 1206 depiction can include a digital image of a character or other representation of the NFT. The first NFT 1206 includes a depiction 1214 of a time remaining until the NFT will be sold

FIG. 12 further illustrates at least one action 1212 that may be performed by a player with respect to each NFT 1206. For example, a player may select a button or provide another input to select an action 1212 relating to an NFT 1206 to “purchase the NFT.” By purchasing the NFT, the player may acquire the NFT and thereby transfer an ownership interest in the NFT to the player. The player may purchase the NFT in some examples with a full ownership interest. In another example, the player may purchase a partial ownership interest in the NFT. In yet another example, the player may rent the NFT for a limited period of time.

A smart contract may define the terms of agreement of the action and execution of code snippets associated therewith. For example, a smart contract may specify that the acquiring party identify a digital wallet from which currency (e.g., cryptocurrency or real currency) will be transferred to the providing party. The transaction between the player and the provider of the NFT can be recorded on a blockchain 942 of the digital ledger infrastructure.

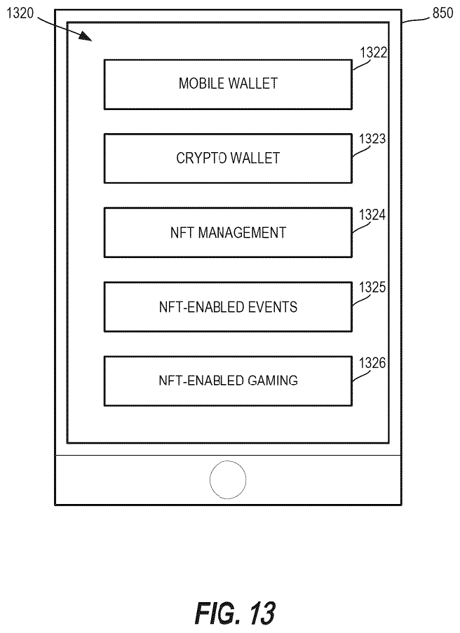

FIG. 13 is a block diagram depicting an example user computing device 850 displaying a graphical user interface 1320 (GUI 1320) of a cross-channel application in accordance with an example embodiment of the present disclosure. GUI 1320 provides user access to various systems of cross-channel application 852. By way of example GUI 1320 may include a first GUI element 1322 (denoted as “mobile wallet 1322” in FIG. 13) that provides input/output functionalities associated with a traditional mobile wallet, such as the ability for a user to provide input and receive displayed information to send and receive payments using traditional currencies via financial accounts. GUI 1320 may include a second GUI element 1323 (denoted as “crypto wallet 1323” in FIG. 13) that provides user I/O functionalities associated with a crypto wallet, such as the ability for a user to provide input and receive displayed information to trade cryptocurrencies recorded on a blockchain. GUI 1320 may include a third GUI element 1324 (denoted as “NFT management 1324” in FIG. 13) that provides user I/O functionalities to manage non-fungible tokens (NFTs). For example, the cross-channel application may enable a user to purchase NFTs, store NFTs, trade NFTs, etc. GUI 1320 may include a fourth GUI element 1325 (denoted as “NFT-enabled events 1325” in FIG. 13) that provides user I/O functionalities for a player to participate in NFT enabled events. GUI 1320 may include a fifth GUI element 1326 (denoted as “NFT-enabled gaming 1326” in FIG. 13) that provides user I/O functionalities for a player to play NFT enabled games. Other suitable GUI configurations may be used having additional, fewer, or alternative functionalities and/or graphical elements for GUI 1320, including those described elsewhere herein.

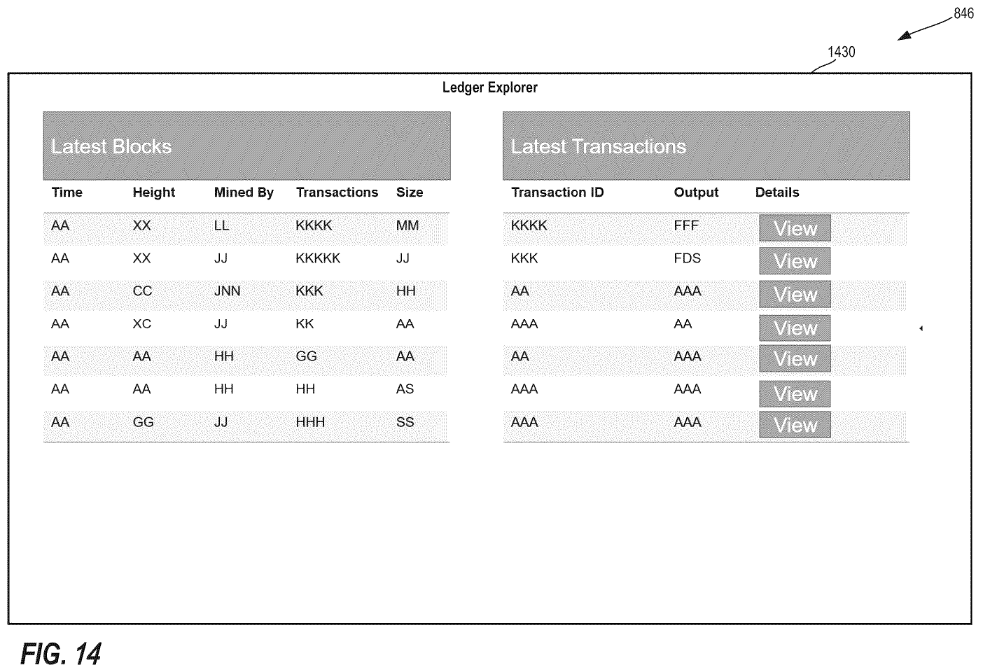

FIG. 14 illustrates an example graphical user interface 1430 (GUI 1430) that may be provided by ledger explorer 846 in accordance with example embodiments of the present disclosure.

Various examples of recording transactions within a blockchain according to example embodiments of the present disclosure can be used. Data for each transaction can be hashed to create a hashed data element for each entry in the digital ledger. For example, an SHA (Secure Hash Algorithm) may be used as a cryptographic hash function to create a one-way entry whose underlying data cannot be retrieved. A SHA-256 algorithm can generate a 256-bit (32-byte) hash using a hashing function. Each hashed data element corresponding to a transaction is added to a block of a blockchain. Each entry may include a transaction identifier, an optional machine identifier, party information such as a public key, details regarding the transaction such as purchase amount and digital wallet transfer information, as well as other content and/or attribute information. The hash value of each hashed data element can be incorporated within the immediately subsequent block to create a system that cannot be altered without detection.

A block generally refers to an aggregation or association of transaction data. A blockchain is an ongoing and growing list of records, called blocks, that are linked and secured using cryptography. There is no specific format required for either a block or a blockchain. Each block typically contains a cryptographic hash linking to the previous block, and transaction data. In order to a provide a distributed ledger, a blockchain is typically managed by a peer-to-peer network that collectively adheres to a protocol for inter-node communication and block validation. After recordation in the blockchain, the data in a block cannot be altered without the alteration of all subsequent blocks.

A blockchain can include a linked hierarchical list of transaction blocks. Chains of related, linked transaction blocks within the hierarchy all relate to an initial genesis block. Each block has a cryptographic value or identity, which is calculated by the header data in the block. Each block contains the hash of the previous block in the chain. Other blockchain architectures may be used in accordance with example embodiments of the present disclosure.

A blockchain can exist as data distributed across network servers on the Internet or other network. It is structured as a chain of blocks, with each block comprising two separate types of information. Each block may include a block header containing information linking to the previous block in the chain, the current time, and cryptographic data that renders the block essentially impossible to remove, modify or corrupt. The block body can include the information about the entry. A blockchain contains, in its block header, mathematical information that renders the data immutable and unchangeable.

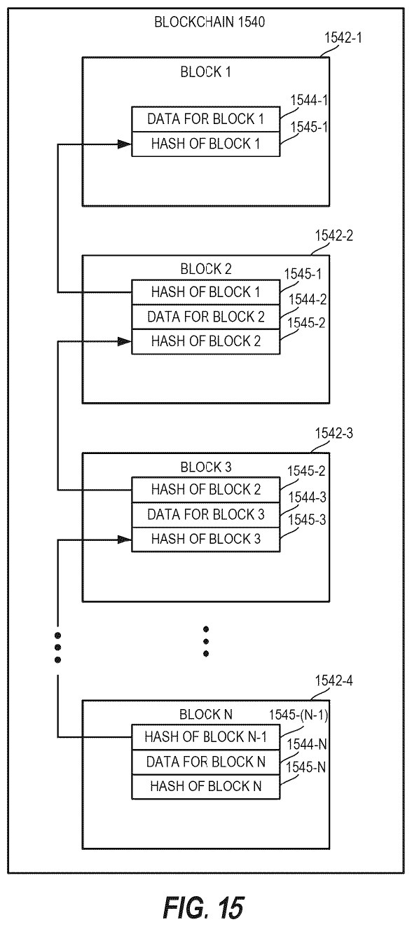

FIG. 15 is a block diagram depicting an example blockchain 1540 according to an example aspect of the present disclosure. A block may include data for the respective block and one or more hashes of the respective block data or data of another block. Blockchain 1540 includes a plurality of blocks 1542 (also referred to as data blocks). Each block includes data 1544 for the respective block (e.g., data for Block 1, data for block 2, . . . , data for block N) and a cryptographic hash 1545 of the data 1544 stored in the block.

In FIG. 15, each data block, or simply block 1542, includes data 1544 for the block and a hashed value, or simply hash 1545, of the data for the block. The data 1544 for a block 1542 may include cryptographic signatures, hash pointers indicating previous transactions, location information such as GPS coordinates, telephone numbers, IP addresses, e-mail addresses, user identifiers, part identifiers, software identifiers, gaming identifiers (e.g., system, channel, session), biometric data, content such as image, video, and/or audio files, etc. The first block (e.g., Block 1) in a particular blockchain can be referred to as the genesis block due to its status as the originating block in the distributed ledger.

The data 1544 in each block (e.g., transaction data) can be organized in a data structure over which the hash of the block is computed. For example, the data structure may include smart contract execution results, account balances, public keys, receipts, etc. New transactions can be submitted to and validated by the network. Upon consensus validation of new transactions, additional blocks including the new transactions may be generated. Each new block is appended to the last block of the blockchain 1540.

Notably, each new block that is appended to the blockchain includes a hash 1545 of the previous block. The cryptographic hash 1545 stored in the new block links the new block to the previous block. As illustrated in FIG. 15, block 2 includes a hash 1545-1 of Block 1 in addition to the hash 1545-2 of the data structure of block 2. Hash 1545-1 links Block 2 to Block 1. In this manner, each appended block is linked to the previous block via a hash of the previous block.

Because each block 1542 includes a hash 1545 of the previous block 1542 (N−1), any change in a previous block will invalidate all subsequent blocks. Such an architecture makes it practically impossible to compromise a blockchain. Any modification to a transaction recorded in a block will affect subsequent blocks unless a new version of each subsequent block is also modified. The computational requirements to achieve such a modification are infeasible due to the ongoing process of adding blocks to a blockchain.

Typically, blocks 1542 may be added to the blockchain 1540 by solving algorithmic rules for transactions in a process referred to as mining. During mining, a computing node generates an acceptable block by satisfying one or more proof of work requirements. If a block is validated, the node provides the block (e.g., broadcasts) to the network. The other nodes of the network validate the new block. If a node validates the new block, it adds it to the blockchain. Blockchain transactions can be represented as messages that can be transported between computing nodes.

Other organizations of transaction data may be used. A blockchain is one example of a mechanism to record transaction data. The architecture and associated transport mechanism of this disclosure system may be applicable to other organizations of transaction data. A blockchain, as in a chain or sequence of blocks, may be any organization of blocks including, without limitation, a block tree, a block graph, or the like. Any blockchain and/or block sequence allocation method can be used in accordance with example embodiments.

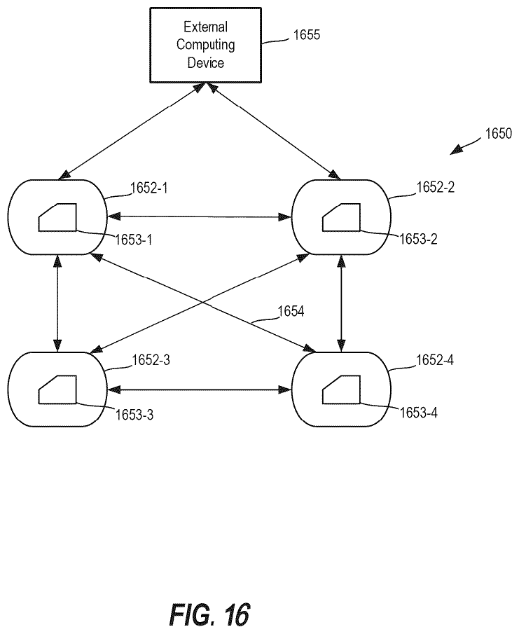

FIG. 16 is a block diagram of an example embodiment of a distributed ledger network 450. A blockchain network is an example of a distributed ledger network 1650. Distributed ledger network may be implemented as a peer-to-peer network to provide secure processing, validation, and recording of transactions by consensus validation to avoid traditional implementations that rely on the trust of persons, entities, programs, etc. that are involved in the transactions. The distributed ledger network 1650 can be used to transfer and record token actions in blockchain based records. The blockchain forms a cryptographically secured list of blocks that are linked by computational hashing.

The distributed ledger network 1650 includes computational nodes 1652-1, 1652-1, 1652-1, and 1652-1. Each computational node includes a respective copy 1653-1, 1653-2, 1653-3, 1653-4 of the digital ledger. Each computational node comprises one or more computing devices having a memory and one or more processors. Each copy of the digital ledger stored at a node is an identical copy. The nodes send and receive messages to update and synchronize the ledger stored and maintained by each node. The nodes may execute decentralized applications or smart contracts for processing messages. By way of example, a message 1654 may be communicated from node 1652-1 to node 1652-4 to transfer an NFT in the distributed ledger network 1650. Similar transmissions may be exchanged between any set of nodes in the distributed ledger network 1650 to perform any NFT action (e.g., create, sell, buy) within any gaming channel. A message may include data that confirms a transfer, and which can be recorded in a block of the blockchain. A message may further include a public key for each party participating in the NFT action, such as a transfer of the NFT.

It should be understood that the term “blockchain” as used herein includes all forms of electronic, computer-based, distributed ledgers. These include consensus-based blockchain and transaction-chain technologies, permissioned and un-permissioned ledgers, shared ledgers, and variations thereof. While Bitcoin and Ethereum may be referred to herein for the purpose of convenience and illustration, it should be noted that the disclosure is not limited to use with the Bitcoin or Ethereum blockchains and alternative blockchain implementations and protocols fall within the scope of the present disclosure.

FIG. 16 depicts an example external computing device 1655 in communication with two of the nodes of network 1650. External computing device 1655 may be a user computing device, intermediary server, gaming server, or other computing device. Although communication with two nodes is depicted, an external computing device may communicate with a single computing node or more than two computing nodes. An external computing device 1655 can receive data such as NFT data from the digital ledger system via a computing node. For example, node 1652-1 may share data from a digital ledger with external computing device 1655. A computing node 1652 may also communicate with an external computing device 1655 to publish transactions from the external computing device. In some examples, an external computing device may communicate with a computing node using one or more APIs or other interfaces. Data exchanged with an external computing device may be encrypted or otherwise encoded to securely transmit ledger data externally from the blockchain network.

The technology discussed herein refers to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

In this description, numerous specific details are set forth. However, it is understood that embodiments of the invention may be practiced without these specific details. In other instances, well-known circuits, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming system comprising:
one or more player gaming devices configured to present one or more digital table games of the gaming system, each of the one or more player gaming devices accessible by players to participate in the one or more digital table games, wherein player participation is represented through a respective player avatar;
a blockchain access system, the blockchain access system in communication with one or more blockchain nodes configured to manage one or more blockchains; and
one or more processors configured to:
receive, via a first player gaming device of the one or more player gaming devices, a player initiation request for a first player associated with the first player gaming device to participate in the one or more digital table games;
in response to the player initiation request, generate a first player avatar for the first player by assigning, via the blockchain access system, an avatar identifier to a blockchain address of the one or more blockchains as a non-fungible token (NFT), the blockchain address associated with the first player;
generate a set of player characteristic parameters for the first player avatar and link the set of player characteristic parameters to the NFT of the avatar identifier, each parameter of the set of player characteristic parameters representing a player tendency within the one or more digital table games;
in response to the first player participating in the one or more digital table games, collect game data representing game conditions of the one or more digital table games and player actions of the first player from the participation;
update the set of player characteristic parameters for the first player avatar based on the collected game data to emulate historical play of the one or more digital table games by the first player; and
generate automatic player actions for the first player avatar within the one or more digital table games without direct player intervention based at least in part on the updated set of player characteristic parameters.

2. The gaming system of claim 1, wherein the first player avatar is assignable to a second player via a blockchain transaction transferring the NFT of the first player avatar from the blockchain address associated with the first player to a blockchain address associated with the second player.

3. The gaming system of claim 2, wherein automatic player actions of the first player avatar are performed for the second player in response to the blockchain transaction.

4. The gaming system of claim 2, wherein, in response to the blockchain transaction, the updated set of player characteristic parameters are further updated in response to game data collected for historical gameplay of the second player.

5. The gaming system of claim 2, wherein updating the set of player characteristic parameters is limited to gameplay and tendencies associated with the first player.

6. The gaming system of claim 1, wherein the one or more processors are configured to generate player action suggestions for the first player based at least in part on the updated set of player characteristic parameters.

7. The gaming system of claim 1, wherein the first player authorizes, via the first player device, automated play of the one or more digital table games by the first player avatar with at least one predefined termination condition, the at least one predefined termination condition causing the automated play to be terminated and includes at least one of a predefined time limit, a predefined credit balance, a predefined number of wagers, or a predefined number of awards.

8. The gaming system of claim 1, wherein at least one parameter of the set of player characteristic parameters is manually adjustable by the first player.

9. A method for providing digital table games and player avatars using a gaming system, the gaming system including one or more player gaming devices to present one or more digital table games, a blockchain access system in communication with one or more blockchain nodes configured to manage one or more blockchains, and one or more processors, the method comprising:
receive, by the one or more processors via a first player gaming device of the one or more player gaming devices, a player initiation request for a first player associated with the first player gaming device to participate in the one or more digital table games;
in response to the player initiation request, generating, by the one or more processors, a first player avatar for the first player by assigning, via the blockchain access system, an avatar identifier to a blockchain address of the one or more blockchains as a non-fungible token (NFT), the blockchain address associated with the first player;
generating, by the one or more processors, a set of player characteristic parameters for the first player avatar and link the set of player characteristic parameters to the NFT of the avatar identifier, each parameter of the set of player characteristic parameters representing a player tendency within the one or more digital table games;
in response to the first player participating in the one or more digital table games, collecting, by the one or more processors, game data representing game conditions of the one or more digital table games and player actions of the first player from the participation;
updating, by the one or more processors, the set of player characteristic parameters for the first player avatar based on the collected game data to emulate historical play of the one or more digital table games by the first player; and
generating, by the one or more processors, automatic player actions for the first player avatar within the one or more digital table games without direct player intervention based at least in part on the updated set of player characteristic parameters.

10. The method of claim 9, wherein the first player avatar is assignable to a second player via a blockchain transaction transferring the NFT of the first player avatar from the blockchain address associated with the first player to a blockchain address associated with the second player.

11. The method of claim 10, wherein the NFT includes a smart contract executable by the at least one blockchain node, the smart contract configured to initiate a second blockchain transaction returning the NFT to the blockchain address associated with the first player after a predefined period of time.

12. The method of claim 10, wherein automatic player actions of the first player avatar are performed for the second player in response to the blockchain transaction.

13. The method of claim 10 further comprising, in response to the blockchain transaction, further updating, by the one or more processors, the updated set of player characteristic parameters in response to game data collected for historical gameplay of the second player.

14. The method of claim 10, wherein updating the set of player characteristic parameters is limited to gameplay and tendencies associated with the first player.

15. The method of claim 9 further comprising generating, by the one or more processors, player action suggestions for the first player based at least in part on the updated set of player characteristic parameters.

16. The method of claim 9, wherein the first player authorizes, via the first player device, automated play of the one or more digital table games by the first player avatar with at least one predefined termination condition, the at least one predefined termination condition causing the automated play to be terminated and includes at least one of a predefined time limit, a predefined credit balance, a predefined number of wagers, or a predefined number of awards.

17. The method of claim 9, wherein at least one parameter of the set of player characteristic parameters is manually adjustable by the first player.

18. A gaming server in communication with one or more player gaming devices and a blockchain access system in communication with one or more blockchain nodes configured to manage one or more blockchains, each of the one or more player gaming devices configured to present one or more digital table games for player participation, wherein the player participation is represented through a respective player avatar, the gaming server comprising:
one or more processors configured to:
receive, via a first player gaming device of the one or more player gaming devices, a player initiation request for a first player associated with the first player gaming device to participate in the one or more digital table games;
in response to the player initiation request, generate a first player avatar for the first player by assigning, via the blockchain access system, an avatar identifier to a blockchain address of the one or more blockchains as a non-fungible token (NFT), the blockchain address associated with the first player;
generate a set of player characteristic parameters for the first player avatar and link the set of player characteristic parameters to the NFT of the avatar identifier, each parameter of the set of player characteristic parameters representing a player tendency within the one or more digital table games;
in response to the first player participating in the one or more digital table games, collect game data representing game conditions of the one or more digital table games and player actions of the first player from the participation;
update the set of player characteristic parameters for the first player avatar based on the collected game data to emulate historical play of the one or more digital table games by the first player; and
generate automatic player actions for the first player avatar within the one or more digital table games without direct player intervention based at least in part on the updated set of player characteristic parameters.

19. The gaming server of claim 18, wherein the first player avatar is assignable to a second player via a blockchain transaction transferring the NFT of the first player avatar from the blockchain address associated with the first player to a blockchain address associated with the second player.

20. The gaming server of claim 19, wherein automatic player actions of the first player avatar are performed for the second player in response to the blockchain transaction.
